(19) United States
(12) Patent Application Publication
(10) Pub. No.: US 2013/0048630 A1
(43) Pub. Date: Feb. 28, 2013

(54) MODULAR, SCALABLE SPILL CONTAINMENT LINING SYSTEM

(71) Applicants: Jason D. Zajicek, Portage, WI (US); Heidi J. Bulgrin, Portage, WI (US); Anthony C. Wangelin, DeForest, WI (US)

(72) Inventors: Jason D. Zajicek, Portage, WI (US); Heidi J. Bulgrin, Portage, WI (US); Anthony C. Wangelin, DeForest, WI (US)

(73) Assignee: Penda Corporation, Portage, WI (US)

(21) Appl. No.: 13/598,846

(22) Filed: Aug. 30, 2012

Related U.S. Application Data
(60) Provisional application No. 61/529,167, filed on Aug. 30, 2011.

(51) Int. Cl. B65D 88/00; B29C 65/02; B29C 65/56; B29C 65/48; B65D 88/52; B65D 88/22

(52) U.S. Cl. 220/4.13; 29/428; 156/60

(57) ABSTRACT

An exemplary embodiment relates to a containment lining system comprising a plurality of connectable thermoplastic body panels, perimeter panels, and corner panels. The panels are adapted for substantially liquid-tight end-to-end connection and side-to-side connection. The perimeter and corner panels are equipped with raised perimeter ribs adapted to provide containment on at least a portion of the perimeter of the lining. The system may be used for containing industrial site waste and leaked fluids, as well as natural precipitation, to provide for controlled recovery or disposal for liquids in the contained lining system and to facilitate removal and transfer of such liquids to a selected destination.

### PRIORITY

This application claims priority to U.S. Provisional Application 61/529,167 filed on Aug. 30, 2011, which is incorporated herein by reference in its entirety.

### BACKGROUND

1. Field of the Invention

The present disclosure relates to a modular, scalable spill containment lining system for natural gas and oil well sites, electrical utility substation sites, industrial work sites, material storage sites, and the like.

2. Related Art

Recent geological discoveries and advances in technology have made it possible to access many new sources of natural gas. For example, deep shale deposits containing natural gas are found across much of the U.S. The Marcellus shale formation is a black, low density, carbonaceous (organic rich) shale that occurs in the subsurface beneath much of Ohio, West Virginia, Pennsylvania, and New York as well as parts of other states including Maryland, Kentucky, Tennessee, and Virginia. The formation was previously thought to contain about 1.9 trillion cubic feet of natural gas, a significant deposit but too diffuse to justify drilling. However, the formation is now believed to contain at least 500 trillion cubic feet of natural gas. Extracting just ten percent of it would be sufficient to meet current nationwide demand for two years and be worth about 1 trillion U.S. dollars. In Pennsylvania alone there are reported to be over 1,400 Marcellus shale natural gas wells sites currently drilling or producing with permits issued for over 4,800 additional sites.

Mineral resource extraction (e.g., mining and drilling) is a heavily regulated industry. For example, drilling sites are required to contain fluids and drilling residue and control surface water runoff in order to effectively minimize pollution and prevent soil erosion.

Under current practices, drilling sites are typically covered with a nylon tarp material. Prior to placing the tarp, a level surface is created by forming a base layer of large rip rap covered with small rip rap and then pea gravel. The nylon tarp is supplied in twelve foot rolls that are heat treated on site to seal them side to side. Because the nylon tarp can be slippery, a “felt” material may be added for better footing, but this can create a trip hazard. This can be a long and expensive process as drilling sites typically range from one to five acres in size. Also, this system is only usable on a flat surface. Most drilling sites have areas that cannot be covered in this manner, such as slopes around the perimeter of the site, where runoff and soil erosion still occur. Increasingly, other outdoor industrial sites, such as electric utility substations, vehicle parking sites, material storage sites, and other sites are required to have liquid containment capabilities.

### SUMMARY

An exemplary embodiment relates to a liquid containment lining system comprising a plurality of corrugated formed plastic body panels, perimeter panels, and corner panels. The tough but resilient plastic panels are adapted for overlapping end-to-end connection and overlapping side-to-side connection to provide a continuous sealed “membrane” suitable for substantial liquid containment. The perimeter and corner panels are molded with raised perimeter ribs adapted to provide containment in at least a portion of the perimeter of the lining.

Another exemplary embodiment relates to a containment lining system comprising a main portion comprising a plurality of corrugated formed plastic body panels that are connected in overlapping fashion to form a corrugated sealed liner. The liner further comprises a plurality of perimeter panels with a raised perimeter rib to provide containment on at least a portion of the perimeter of the lining.

These and other features and advantages of various embodiments of systems and methods according to this invention are described in, or are apparent from, the following detailed description of various exemplary embodiments of various devices, structures, and/or methods according to the present disclosure.

### BRIEF DESCRIPTION OF THE DRAWINGS

Various exemplary embodiments of the systems and methods according to the present disclosure will be described in detail, with reference to the following figures, wherein:

FIG. 1 is a top plan view of an exemplary gas or oil drill site with an exemplary embodiment of a modular, scalable spill containment lining system having a perimeter of a desired shape schematically shown in rectangular form by solid lines, according to the present disclosure;

FIG. 2 is a cross-sectional not-to-scale side view of the lining system of FIG. 1;

FIG. 3 is a partial cross-sectional side view of the lining system of FIG. 1 and exemplary embodiments of an erosion control system with a drainage trench according to the present disclosure;

FIG. 4 is an isometric view of a body portion of the lining system of FIG. 1;

FIG. 5 is an isometric view of an exemplary embodiment of a containment liner body panel according to the present disclosure;

FIG. 6 is a top view of the panel of FIG. 5;

FIG. 7 is an end view of the panel of FIG. 5;

FIG. 8 is a side view of the panel of FIG. 5;

FIG. 9 is a partial end view of the panel of FIG. 5;

FIG. 10 is an isometric view of a first exemplary embodiment of a containment liner right perimeter section according to the present disclosure;

FIG. 11 is a top view of the right perimeter section of FIG. 10;

FIG. 12 is a side view of the right perimeter section of FIG. 10;

FIG. 13 is an end view of the right perimeter section of FIG. 10;

FIG. 14 is an isometric view of an exemplary embodiment of a pad liner right perimeter section according to the present disclosure;

FIG. 15 is a top view of the left perimeter section of FIG. 14;

FIG. 16 is a side view of the left perimeter section of FIG. 14;

FIG. 17 is an end view of the left perimeter section of FIG. 14;

FIG. 18 is an isometric view of an exemplary embodiment of a containment liner upstream perimeter section according to the present disclosure;

FIG. 19 is a top view of the upstream perimeter section of FIG. 18;

FIG. 20 is a side view of the upstream perimeter section of FIG. 18;

FIG. 21 is an end view of the upstream perimeter section of FIG. 18;

FIG. 22 is an isometric view of an exemplary embodiment of a containment liner downstream perimeter section according to the present disclosure;

FIG. 23 is a top view of the downstream perimeter section of FIG. 22;

FIG. 24 is a side view of the downstream perimeter section of FIG. 22;

FIG. 25 is an end view of the downstream perimeter section of FIG. 22;

FIG. 26 is an isometric view of an exemplary embodiment of a containment liner upper right upstream corner section according to the present disclosure;

FIG. 27 is a top view of the right upstream corner section of FIG. 26;

FIG. 28 is a left side view of the upper left corner of FIG. 26;

FIG. 29 is an end view of the upper left corner of FIG. 26;

FIG. 30 is an isometric view of an exemplary embodiment of a containment liner right downstream corner section according to the present disclosure;

FIG. 31 is a top view of the right downstream corner section of FIG. 30;

FIG. 32 is a right side view of the right downstream corner section of FIG. 30;

FIG. 33 is an end view of the right downstream corner section of FIG. 30;

FIG. 34 is an isometric view of an exemplary embodiment of a containment liner left upstream corner section according to the present disclosure;

FIG. 35 is a top view of the left upstream corner section of FIG. 34;

FIG. 36 is a right side view of the left upstream corner section of FIG. 34;

FIG. 37 is an end view of the left upstream corner section of FIG. 34;

FIG. 38 is an isometric view of an exemplary embodiment of a containment liner left downstream corner section according to the present disclosure;

FIG. 39 is a top view of the left upstream corner section of FIG. 38;

FIG. 40 is a side view of the left upstream corner section of FIG. 38;

FIG. 41 is an end view of the left upstream corner section of FIG. 38;

FIG. 42 is an isometric view of a first exemplary embodiment of a containment liner right perimeter panel according to the present disclosure;

FIG. 43 is an end view of the right perimeter panel of FIG. 42;

FIG. 44 is an isometric view of an exemplary embodiment of a containment liner left perimeter panel according to the present disclosure;

FIG. 45 is an end view of the left perimeter panel of FIG. 44;

FIG. 46 is an isometric view of an exemplary embodiment of a containment liner upstream perimeter panel according to the present disclosure;

FIG. 47 is an end view of the upstream perimeter panel of FIG. 46;

FIG. 48 is a side view of the upstream perimeter panel of FIG. 46;

FIG. 49 is an isometric view of an exemplary embodiment of a containment liner downstream perimeter panel according to the present disclosure;

FIG. 50 is an end view of the downstream perimeter panel of FIG. 49;

FIG. 51 is a side view of the downstream perimeter panel of FIG. 49;

FIG. 52 is an isometric view of an exemplary embodiment of a containment liner right upstream corner panel according to the present disclosure;

FIG. 53 is an isometric view of an exemplary embodiment of a containment liner left upstream corner panel according to the present disclosure;

FIG. 54 is an isometric view of an exemplary embodiment of a containment liner left downstream corner panel according to the present disclosure;

FIG. 55 is an isometric view of an exemplary embodiment of a containment liner right downstream corner according to the present disclosure;

FIG. 56 is a top view of two of the panels of FIG. 5 connected end-to-end according to the present disclosure;

FIG. 57 is an exploded end cross-sectional view of the panels of FIG. 56, taken along the line A-A, showing an intermediate gasket;

FIG. 58 is a top view of two of the bi-panel assemblies of FIG. 56 connected side-to-side according to the present disclosure;

FIG. 59 is an exploded end cross-sectional view of the bi-panel assemblies of FIG. 58 along the line B-B;

FIG. 60 is an exploded isometric view of the bi-panel assemblies of FIG. 58;

FIG. 61 is a partial isometric view of the junction of the four panels of FIG. 58; and

FIG. 62 is a cross-sectional view of the junction of the four panels of FIG. 61 along the line C-C.

FIG. 63 is a cross-sectional not-to-scale view of another exemplary containment lining system.

FIG. 64 is a cross-sectional not-to-scale view of still another exemplary containment lining system.

FIG. 65 is a schematic end view of a pair of body panel edge portions for a containment lining system positioned for electrofusion plasma welding with plasma welding rods extending between the panels prior to welding.

FIG. 66 is an isometric view of one or more examples of embodiments of a containment liner body panel.

FIG. 67 is a cross sectional view of the panel of FIG. 66, taken along line 67-67 of FIG. 66.

FIG. 68 is an isometric view of one or more examples of embodiments of a sheet coupling assembly for use in coupling containment liner body panels shown in FIG. 66.

FIG. 69 is a cross sectional view of the sheet coupling assembly of FIG. 68, taken along line 69-69 of FIG. 68.

FIG. 70 is an isometric view of one or more examples of embodiments of a sheet coupling assembly, wherein each thermoplastic weld rod has greater surface area than the weld rods illustrated in FIG. 68.

FIG. 71 is a cross sectional view of the sheet coupling assembly of FIG. 70, taken along line 71-71 of FIG. 70.

FIG. 72 is an isometric view of one or more examples of embodiments of a perimeter panel adapted to be coupled to an outer edge portion of the containment liner body panel of FIG. 66.

FIG. 73 is a cross sectional view of the perimeter panel of FIG. 72, taken along line 73-73 of FIG. 72.

FIG. 74 is an isometric view of one or more examples of embodiments of a perimeter panel coupling assembly for use in coupling perimeter panels shown in FIG. 72.

FIG. 75 is a cross sectional view of the perimeter panel coupling assembly of FIG. 74, taken along line 75-75 of FIG. 74.

FIG. 76 is an isometric view of one or more examples of embodiments of a corner perimeter panel adapted to be coupled to the outer edge portions of an outer corner of a liner body panel shown in FIG. 66.

FIG. 77 is an end view of the corner perimeter section of FIG. 76.

FIG. 78 is an isometric exploded view of a portion of a lining system, specifically including an outer perimeter corner panel and associated perimeter panels, wherein a plurality of panels of FIG. 66 are being coupled together, the ends of the sheet coupling assemblies being shown in broken lines to demonstrate they can extend further than the illustrated panels.

FIG. 79 is an isometric view of a portion of a lining system of FIG. 78, illustrating the one or more embodiments of the various elements coupled together to form a liquid tight and/or water tight sealed lining system.

It should be understood that the drawings are not necessarily to scale. In certain instances, details that are not necessary to the understanding of the invention or that render other details difficult to perceive may have been omitted. It should be understood, of course, that the invention is not necessarily limited to the particular embodiments illustrated herein.

### DETAILED DESCRIPTION OF THE EXEMPLARY EMBODIMENTS

The present disclosure relates to a scalable, modular spill containment lining system for containing and controlling the flow of water and/or other fluids, whether from natural rain, snow, or man-made sources, on industrial sites, such as oil and natural gas wells, electric utility substations, vehicle parking areas, and the like. Natural gas drilling areas are typically one to five square miles in size. A single well site is typically one to four acres in size containing the drilling equipment, materials and supplies, vehicles for transporting supplies and personnel, and other equipment. The containment lining system of the present disclosure is substantially installed below the top surface of a well site to prevent seepage and contain any fluid contaminants, fluid-borne contaminants or precipitation.

In various exemplary embodiments, the disclosed system comprises a plurality of corrugated ground covering molded plastic panels coupled together in overlapping fashion. In some exemplary embodiments, the system may include one or more molded plastic ditches that comprise one or more coupled components. In such embodiments, the ditch components are coupled or juxtaposed in overlapped relation to the ground cover components and the system to channel liquids on the ground cover components into the ditches. The ditches may provide or discharge to a conduit to an outlet or destination like a retention pond or treatment facility. In various exemplary embodiments, the disclosed system has a peripheral rib or wall extending from all margins of the ground cover components, to permit contained liquids to be pumped from the containment area for treatment or proper disposal.

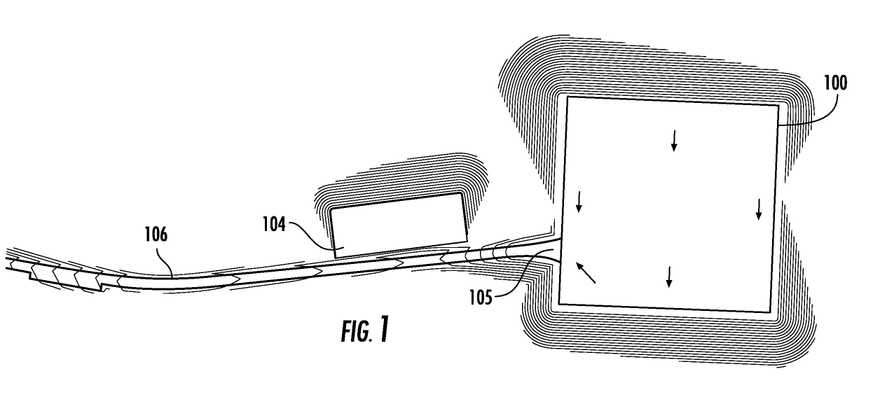

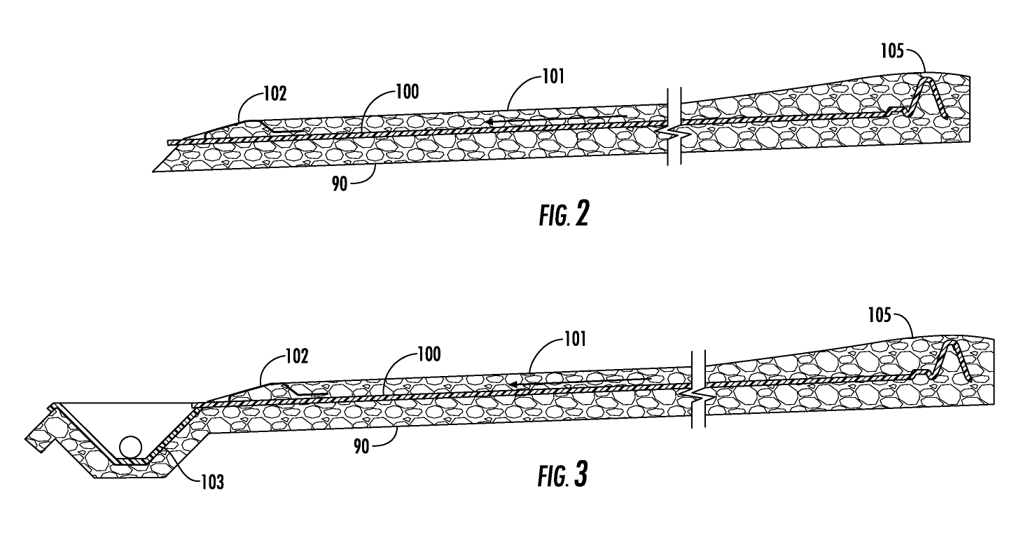

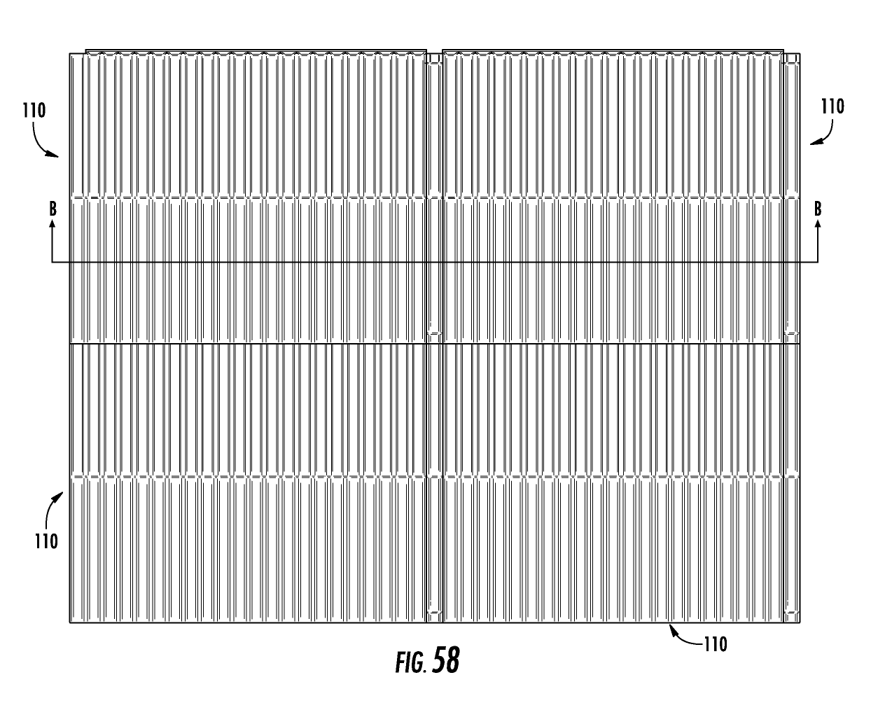

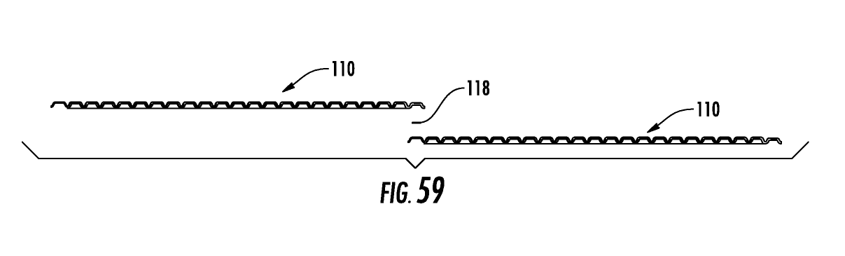

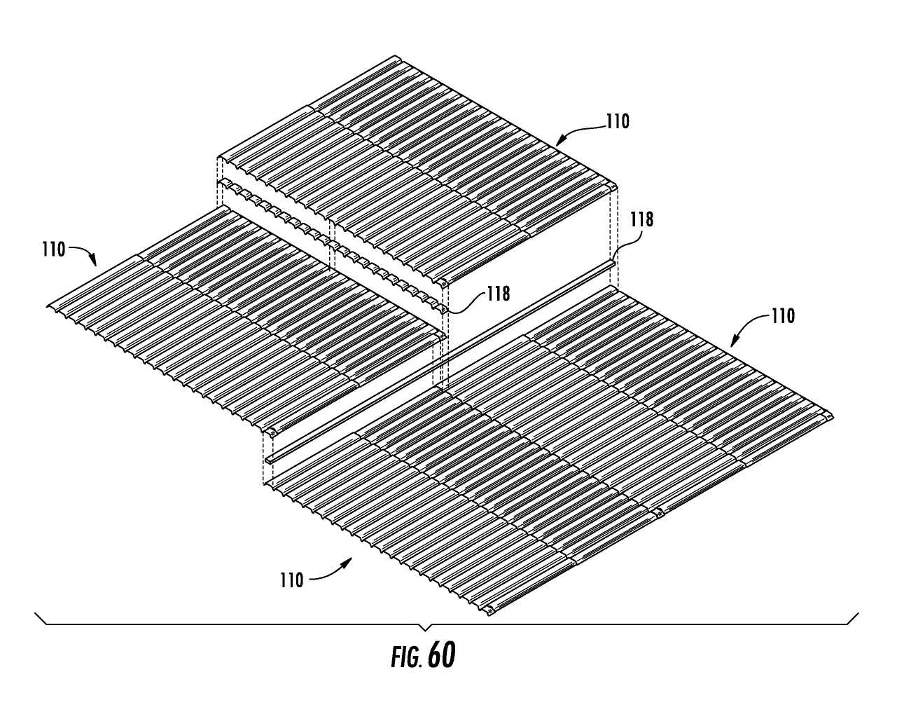

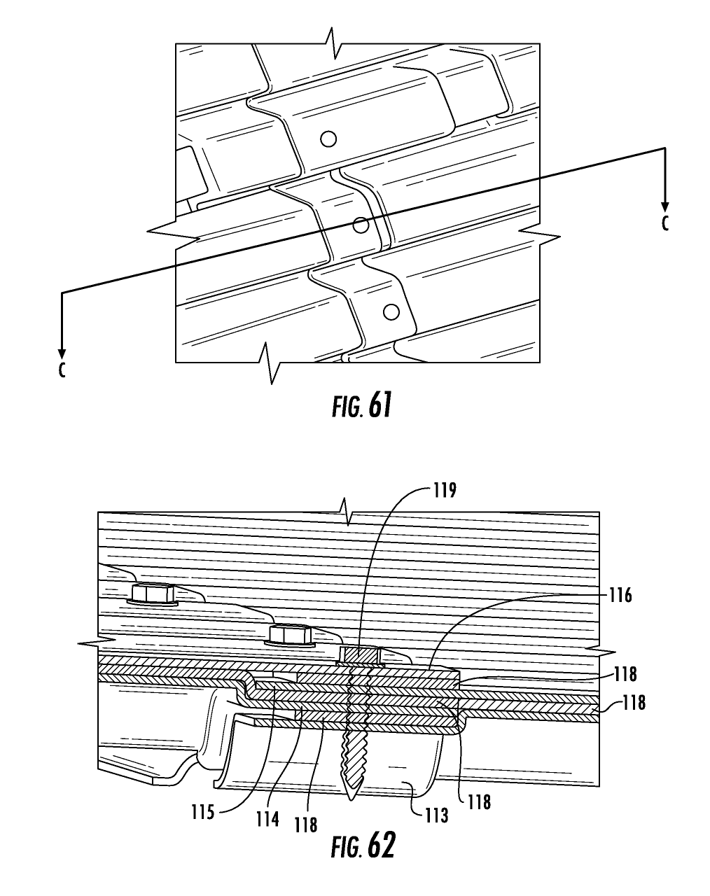

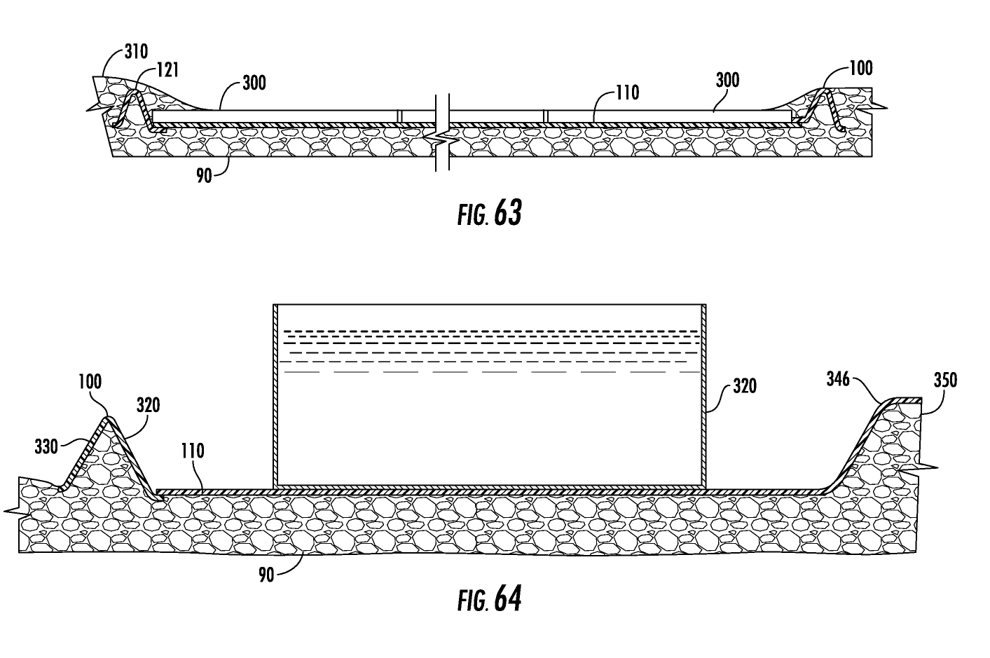

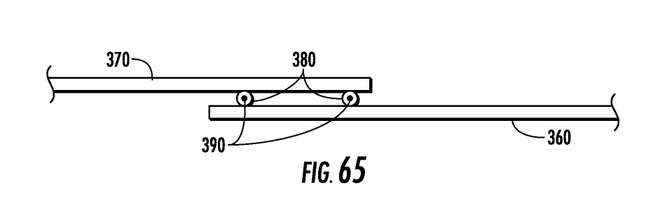

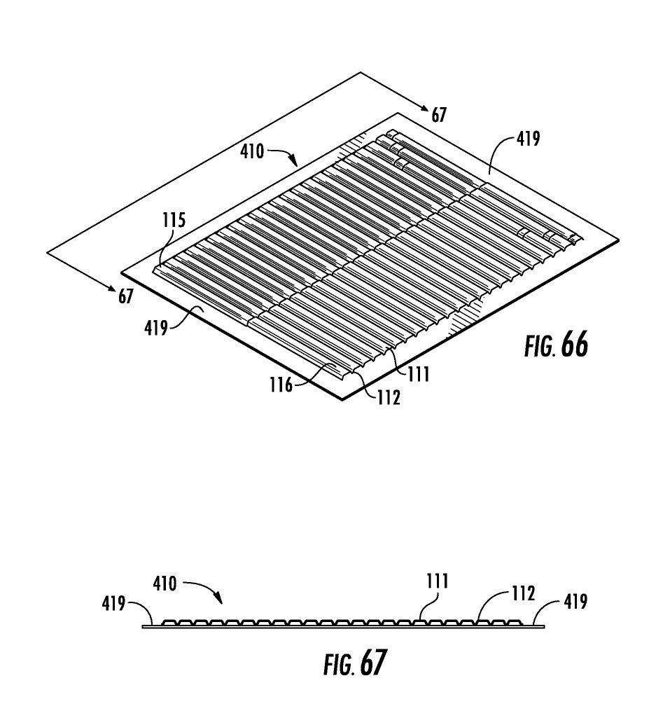

In various exemplary embodiments, the disclosed liner comprises a plurality of various interconnected panels 110 which may be advantageously extruded or molded from high density polyethylene (HDPE), or other suitably tough, flexible, durable, moldable or extrudable plastic materials. FIGS. 1 and 2 show a simplified exemplary embodiment of a drill site (many of the features necessary for drilling or operating a well are not shown). Prior to installation of a drill pad spill containment lining system 100, the site may be prepared by grading it to a suitable grade and/or by creating an appropriate base subsurface 90 (e.g., large and/or small riprap, gravel, pea gravel, and/or sand or other small granular material). The subsurface 90 is laid on an underlying natural soil or fill material (not shown) prepared and graded or shaped by conventional methods and materials. The lining system 100 is assembled and installed on the subsurface 90. As shown in FIGS. 2 and 3, the lining system 100 may be installed at a slight slope (e.g., of about a 1 to 2% grade) to direct water flow to a desired outlet location or side of the lining system 100. In various exemplary embodiments, as illustratively shown in FIGS. 63 and 64, the lining system may be installed in a flat, level condition with raised perimeter panels extending continuously around all sides and margins of the lining system to contain fluids which might be received by the lining system. As shown in FIG. 4, the lining system 100 may be assembled by connecting a plurality of panels 110, which may be corrugated, in an overlapping manner. In an exemplary embodiment, gasket strips 118 may be placed between overlapping panel edges, which may be connected by screws and/or adhesives, as shown in FIGS. 57-62, or by plasma welding, as shown in FIG. 65, all as described below.

FIG. 1 also shows a production pad 104 located near the drill site to accommodate vehicles, equipment, personnel and/or oil/gas tanks for temporary storage of well production products. The lining system 100 described herein for the well pad can be equally well utilized for the production site 104.

In various exemplary embodiments, as illustrated in FIGS. 2 and 3, the liner 100 may be covered by a gravel pad 101. The gravel pad 101 provides a flat load-bearing surface for supporting walking equipment or vehicles. In various exemplary embodiments, the gravel pad will be at least about 6 to 12 inches deep. The gravel pad 101 preferably comprises small rip rap or similarly sized stone that is large enough to provide interstitial space for the passage of water and small enough for foot or vehicle traffic. In various exemplary embodiments, the depth of the gravel pad may be varied. For example, the depth of the gravel pad may be increased to provide a crown or “bridge” 105 at a vehicle access point along the perimeter to facilitate passage of vehicles onto or off from the lining system 100 via service road 106, without damage to the perimeter structure of the lining system.

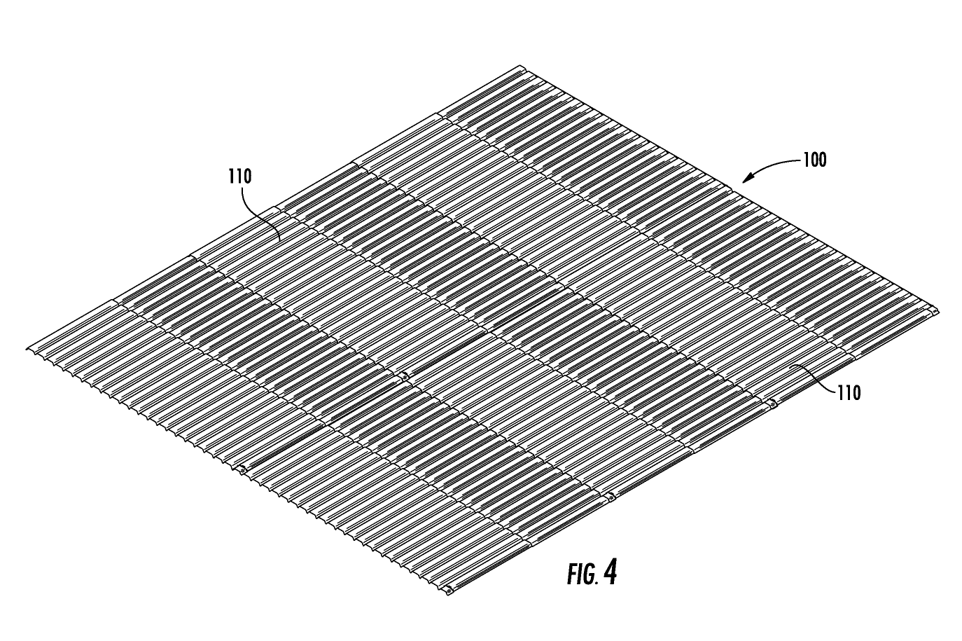

In various exemplary embodiments, as shown in FIG. 3, liquids travel down the inclined lining system 100 to an optional trench or ditch 103. In various exemplary embodiments, the corrugated panels 110 are installed such that the predominant direction of the corrugations and water flow is downstream, generally parallel to the ribs 111, but more complicated flow patterns may include flows in different directions. For purposes of this description, the referenced “upstream” and “downstream” directions will extend parallel to the ribs 111 and valleys 112 as identified in FIGS. 5 and 8. The ditch 103 may then convey the liquids to an outlet or destination, such as a retention pond or water treatment facility. In various other exemplary embodiments, the lining system 100 may be installed such that liquids drain toward one or more interior outlets, such as a sumps or drainage pipes. In various exemplary embodiments, the main panels 110, which may be corrugated or flat planar panels, may be installed level, as shown in FIGS. 63 and 64, with pumps (not shown) used to pump out any leaked or accumulated fluids for further use or proper disposal.

In various exemplary embodiments, an erosion control system 102 is used to prevent material from the gravel pad 101 from falling into the ditch 103. The ditch is comprised of one or more molded plastic components coupled together to form a generally V-shaped or U-shaped ditch, as more fully identified below. The erosion control system 102 is made of a “blanket” of porous geotextile fabric 102 sheet material that allows water and other liquids, but not aggregate, to pass from the gravel pad 101. In various exemplary embodiments, as shown in FIG. 3, the geotextile fabric 102 sheet material is placed around a quantity of aggregate with the ends secured in place under additional aggregate.

In various exemplary embodiments, the ditch 103 comprises a plurality of coupled ditch segments (not shown). In some embodiments, each ditch segment is a single, integral unit forming a ditch 103. In other embodiments, the ditch segments may comprise multiple components coupled together to form ditch segments. In various exemplary embodiments, the ditch component comprises alternating ribs and valleys or corrugations similar to body panel 110, as described below, except the ribs will generally run transversely to the axis of the ditch segments. In various exemplary embodiments, the ribs and valleys of the ditch 103 and lining system 100, or body panels 111, may be adapted for tight, overlapping connection. An exemplary modular, sealable ditch is disclosed in U.S. patent application Ser. No. 12/962,323, published as 2011/0135392 A1, the entire disclosure of which is incorporated herein by reference. The size and shape of the ditch 103 may be varied as needed to accommodate the needs of a given site and application.

In various exemplary embodiments, as illustrated in FIG. 4, the lining system 100 is assembled from a plurality of panels 110. FIG. 4 shows an exemplary liner section 100 comprised of six liner panels 110 in a 2×3 configuration.

In various exemplary embodiments, the main body of the lining system is assembled from a plurality of individual body liner panels 110, shown in FIGS. 5-8. In various exemplary embodiments, body panel 110 is generally rectangular in shape and corrugated with alternating relatively wide, flat ribs or ridges 111 and narrow valleys 112. In various exemplary embodiments, the ribs 111 may be about 1.0 inch tall and 4.0 inches wide (measured between adjacent valley 112 bottoms). In various exemplary embodiments, side walls of ribs 111 are angled or sloped at about 25 degrees from vertical, but the sidewall angle may be varied. The corrugated pattern provides greater strength and rigidity to the body panels 110 and other components. It should be noted that size and shape of the ribs may vary within the scope of the present disclosure and claims to meet the design needs of the targeted user group.

In various exemplary embodiments, the body panel 110 may be about 100 inches long (i.e., the dimension perpendicular to the ribs) by about 75 inches wide (i.e., the dimension parallel to the ribs). In various exemplary embodiments, the body panel 110 corrugations are about 1.15 inches high. In various exemplary embodiments, the valleys 112 are approximately 4.16 inches apart (i.e., distance between the bottom points of adjacent valleys) and the sides of the valleys 112 are inclined at an angle of about 115 degrees from horizontal (at the base). In various exemplary embodiments, the panels will be formed from high-density polyethylene (HDPE) sheets having a thickness of 0.125 inch, but thinner or thicker sheet materials ranging generally from about 0.060 to about 0.250 inches may be used depending upon the application, required useful panel life or conditions of use.

HDPE is a highly crystalling lightweight thermoplastic material having outstanding characteristics of chemical resistance, toughness (even at low temperatures), dielectric properties, water vapor impermeability, and relatively high softening temperature. The HDPE sheet material may be formed from virgin HDPE or recycled HDPE and/or other compatible blended thermoplastic materials which are known to share or enhance the properties of HDPE for particular site conditions or requirements. Accordingly, all or substantial portions of the panels may be comprised of recycled material.

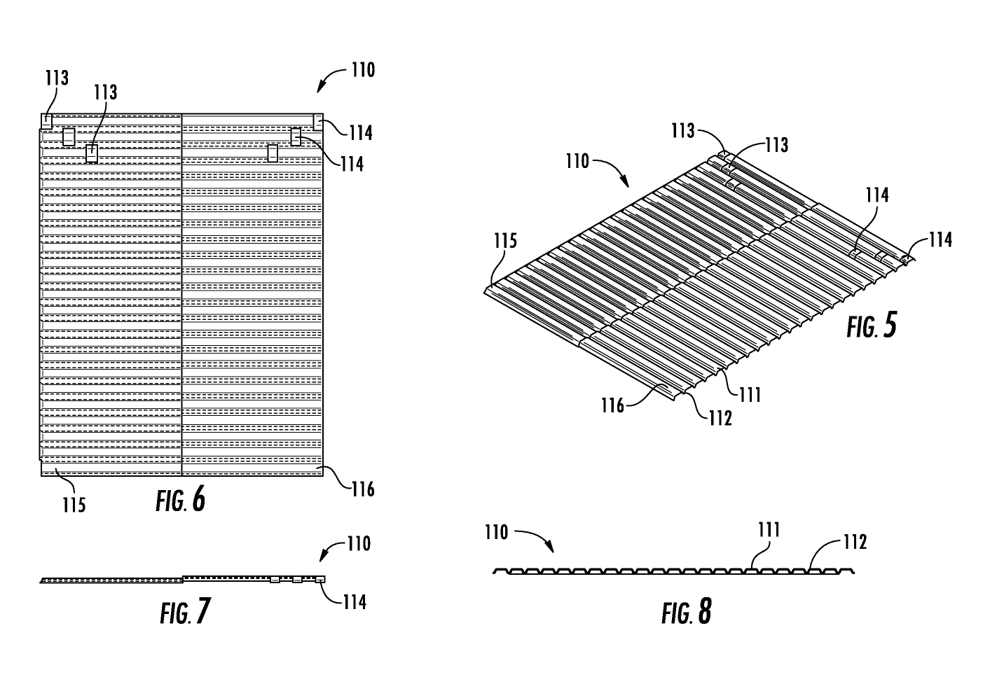

In various exemplary embodiments, the body panels 110 have an offset upstream right corner 113 and an offset downstream right corner 114. As discussed in more detail below, the offset corners facilitate overlapping connection of body panels 110. In various exemplary embodiments, the body panel 110 is formed with multiple offsets 113 and 114, as shown in FIGS. 6 and 7. As described in detail below, the panels 110 are overlapped and connected with fasteners. Once the lining system 100 is no longer needed (e.g., after wells are in operation, or are no longer producing), all or part of the lining system 100 may be removed by cutting away overlapped panel portions such that an interior pair of offsets 113 and 114 are adjacent to the new upstream and downstream edges. This facilitates reuse of the body panels 110 at another well pad or production pad site. The cut-away scrap portions may be cleaned, shredded, reheated and reformed for use in new body panels 110 or other unrelated thermoplastic applications to substantially eliminate waste. Likewise, the used body panels 110 themselves may be cleaned, shredded, reheated, reformed and thus recycled, into new body panels or other useful formed articles.

In various exemplary embodiments, as shown in FIG. 9, body panel 110 may include a gasket trench 117 extending across the width of the body panel 110 crossing the ridges 111 and valleys 112. The gasket trench 117 provides a space for placement of a flexible, resilient gasket strip (not shown in FIG. 9) or other compressible material (e.g., sponge cell foam) which may be placed or secured to provide a more watertight connection between overlapped body panels 110, as discussed in more detail below. In various exemplary embodiments, the trench 117 is sized to accommodate a one inch wide by 0.25 inch thick sealing strip 118 (See FIG. 57) that will be compressed to about 0.125 inches in thickness when positioned and fastened between overlapping panels 110.

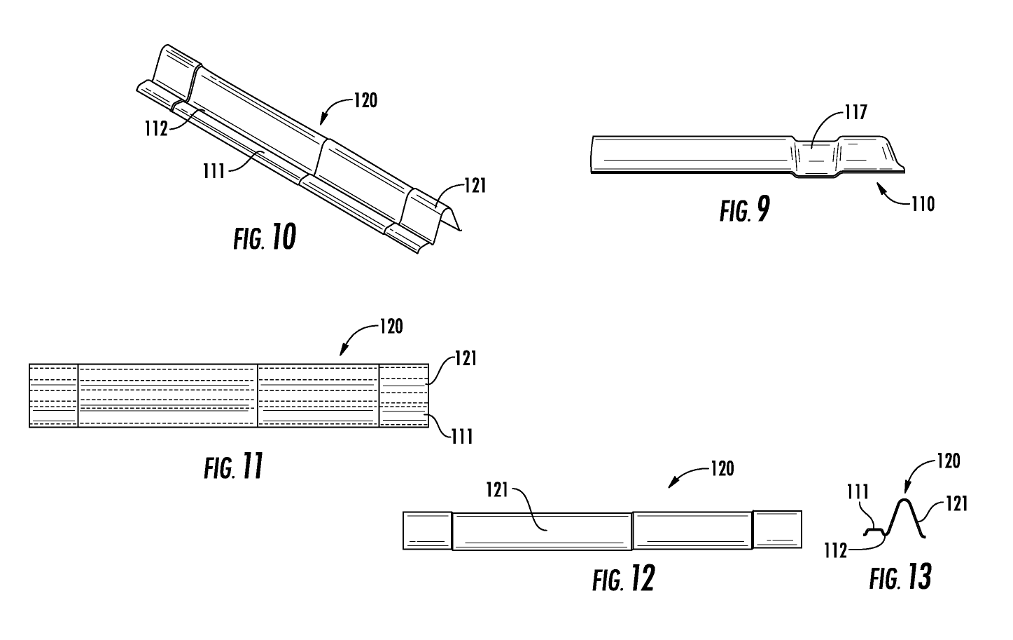

FIGS. 10-13 show an exemplary embodiment of a left perimeter panel 120. In various exemplary embodiments, a left perimeter panel 120 is generally rectangular in shape and corrugated with at least one edge portion comprising a flat rib 111 and narrow valley 112 substantially matching the corrugations of body panel 110. In various exemplary embodiments, a right perimeter panel 120 also comprises a raised perimeter rib 121 along its opposite edge portion comprising a similar flat rib 111 edge. In various exemplary embodiments, the right perimeter panel 120 is attachable to a body panel 110 by overlapping edge portion flatrib 111 of the right perimeter panel 120 and the rightmost edge portion rib edge 111 of the body panel 110, preferably with a gasket or other sealant placed between the two components. The raised perimeter rib 121 provides peripheral containment for the aggregate of the gravel pad 101 loaded on top of the lining system 110, wherein the edge portions of the right perimeter panels 120 are attached to the edge portions of the body panels 110 forming the right side of the assembled main body lining system 100 (as referenced as if looking upstream toward the assembled lining system from the downstream end of the lining system). Typically, the lining system will be constructed starting at the downstream end. Each next succeeding upstream panel showed overlap the adjacent downstream panel. If the system is constructed on level ground, the starting end would be considered the “downstream” end for construction purposes.

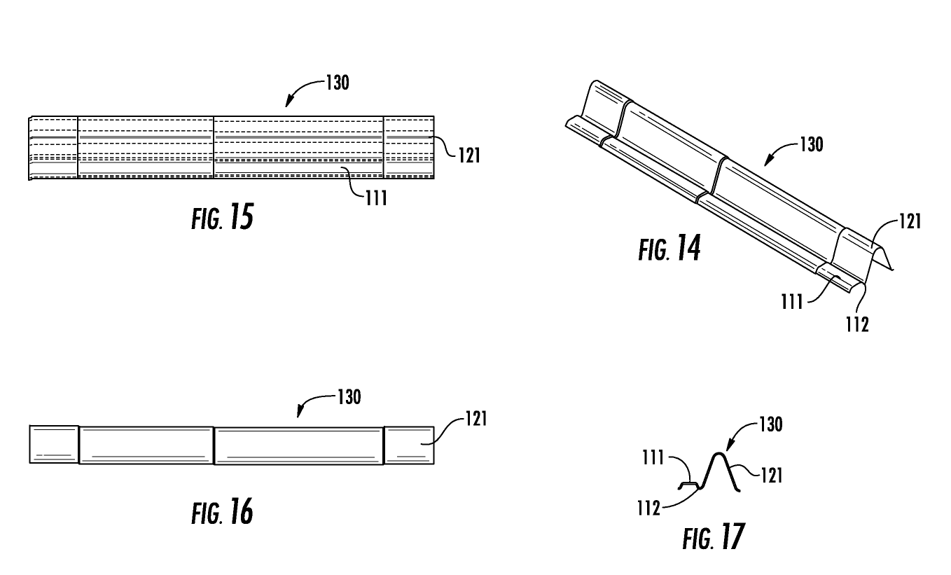

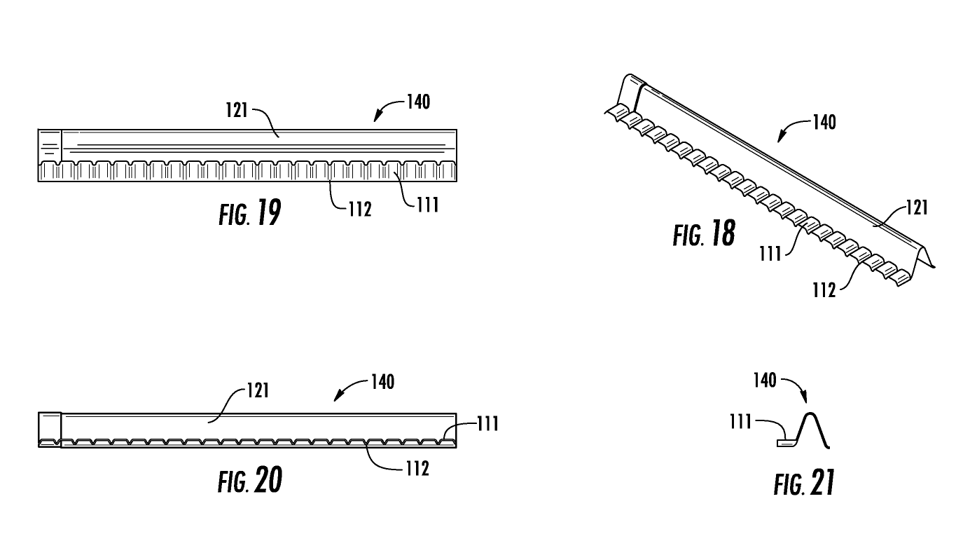

FIGS. 14-17 show an exemplary embodiment of a left perimeter panel 130. In various exemplary embodiments, a left perimeter panel 130 is generally rectangular in shape and with a corrugated edge portion having at least one flat rib 111 and narrow valley 112 substantially matching the corrugations of body panel 110. In various exemplary embodiments, a left perimeter panel 130 also comprises a raised perimeter rib 121 along its left edge opposite the flat rib 111. In various exemplary embodiments, a left perimeter section 130 is attachable to a body panel 110 by overlapping edge portion flat rib 111 of a left perimeter section 130 and the leftmost rib 111 of the body panel 110 (as referenced looking downstream), preferably with a gasket or other sealant placed between the two components, in the same manner as the right perimeter panel 120 is attached on the right side of the lining system 100, and serves the same peripheral containment function as the right peripheral panels 120. Although the left and right perimeter sectional panels 120 and 130 may be structurally the same, they are assembled in the lining system 100 with their downstream oriented ends each overlapping the upstream ends of the next downward positioned perimeter panel.

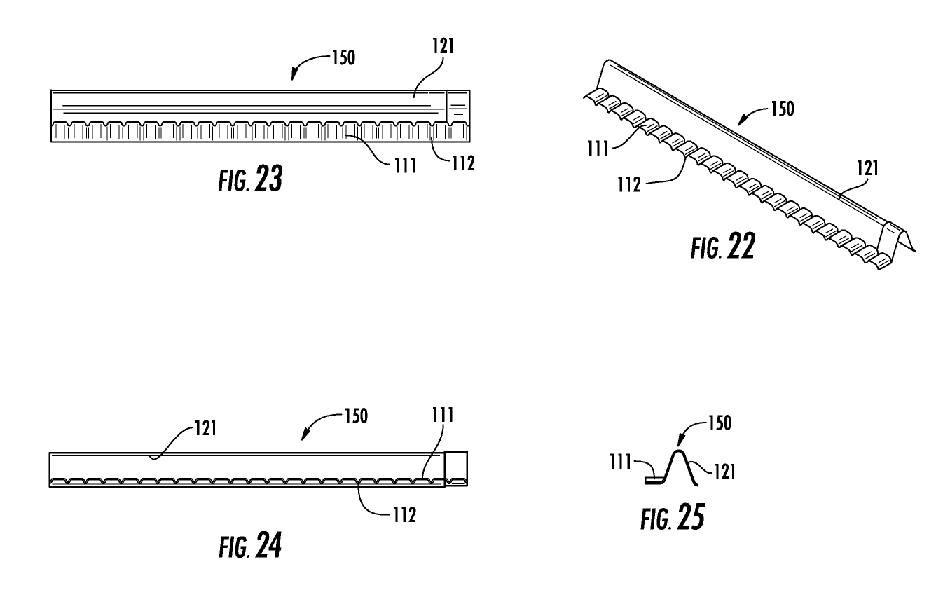

FIGS. 18-21 show an exemplary embodiment of an upstream perimeter panel 140. In various exemplary embodiments, upstream perimeter panel 140 is generally rectangular in shape and corrugated along its downstream side with an edge portion having alternating short flat ribs 111 and narrow valleys 112 substantially matching the ribs 111 and valleys 112 of body panel 110. In various exemplary embodiments, an upstream perimeter panel 140 also comprises a raised perimeter rib 121 along its upstream edge. In various exemplary embodiments, an upstream perimeter panel 140 is attachable to a body panel 110 by overlapping the short flat ribs 111 and valleys 112 of the downstream edge portion of the upstream perimeter section 140 with the matching ribs 111 and valleys 112 at the upper edge of the body panel 110, preferably with a gasket or other sealant placed between the two components. The raised perimeter 121 of the upstream perimeter panel 140 provides the same peripheral containment function along the upstream edge of the lining system 110 as the previously described perimeter ribs 121.

FIGS. 22-25 show an exemplary embodiment of a downstream perimeter section 150. In various exemplary embodiments, downstream perimeter section 150 is generally rectangular in shape and corrugated with alternating flat ribs and narrow valleys substantially matching the corrugations of body panel 110. In various exemplary embodiments, a downstream perimeter panel 150 also comprises a raised perimeter rib 121 along all or part of its downstream edge for similar containment purposes. In various exemplary embodiments, a downstream perimeter panel 150 is attachable to a body panel 110 by overlapping the short flat ribs 111 and valleys 112 of the upstream edge portion of the downstream perimeter panel 150 with the ribs 111 and valleys 112 at the downstream edge of the first adjacent upstream body panel 110, preferably with a gasket or other sealant placed between the two components.

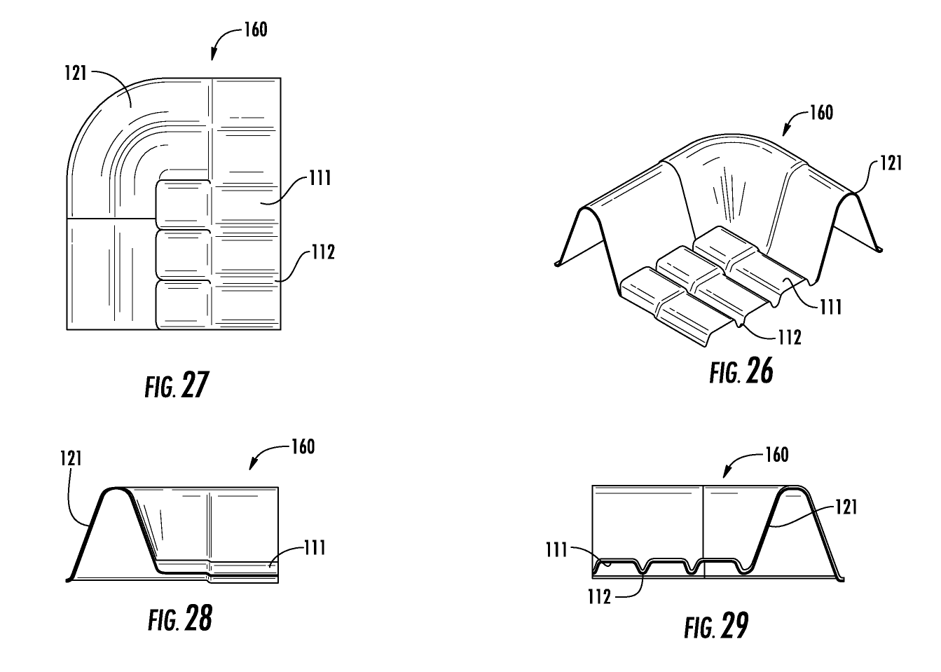

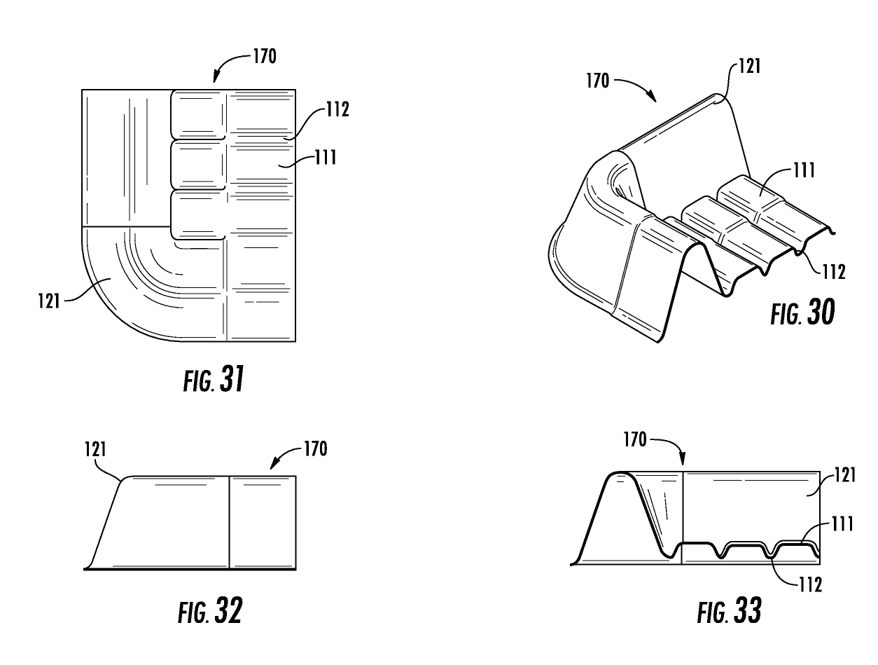

FIGS. 26-29 show an exemplary embodiment of a right upstream corner panel 160. In various exemplary embodiments, right upstream corner panel 160 is generally rectangular in shape and corrugated with alternating flat ribs and narrow valleys substantially matching the adjacent corrugations of body panel 110. Right upstream corner panel 160 also comprises a continuous raised perimeter rib 121 along its top edge and right edge.

FIGS. 30-33 show an exemplary embodiment of a right downstream corner panel 170. In various exemplary embodiments, a right downstream corner panel 170 is generally rectangular in shape and corrugated with an edge portion having alternating flat ribs 111 and narrow valleys 112 substantially matching the corrugations of body panel 110. A right downstream corner panel 170 also comprises a continuous raised perimeter rib 121 along its bottom edge and right edge.

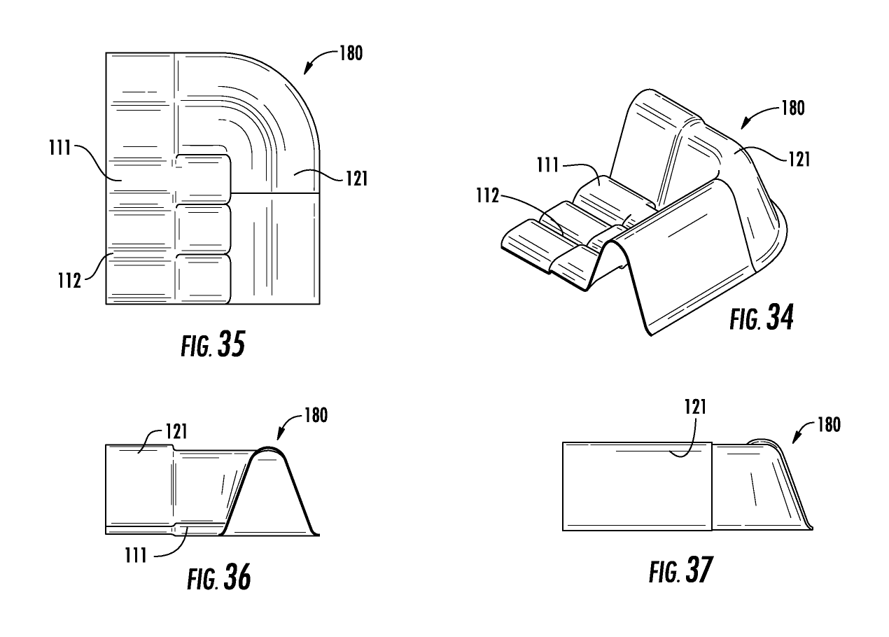

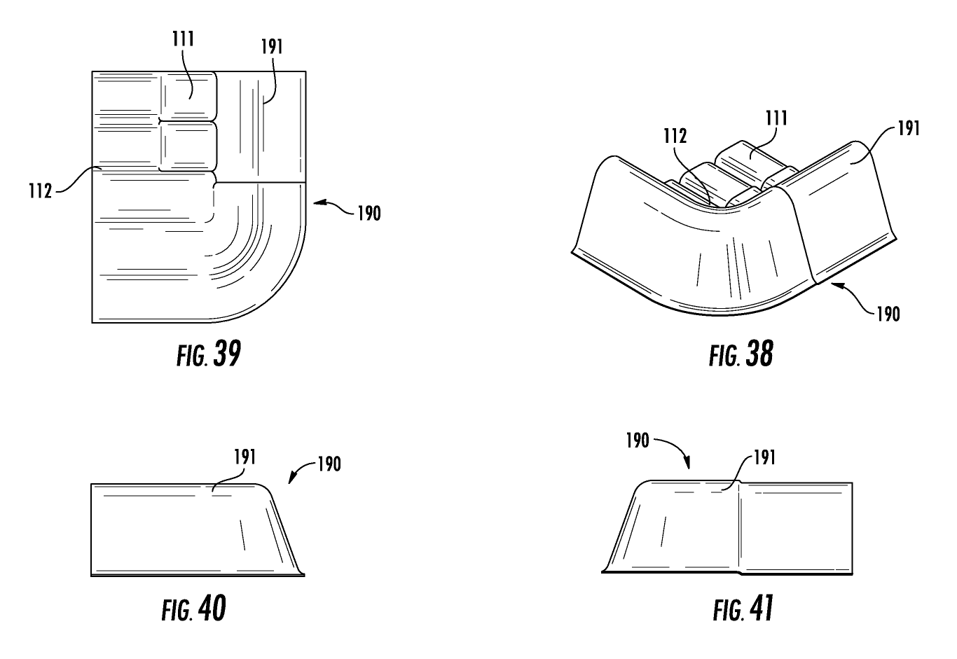

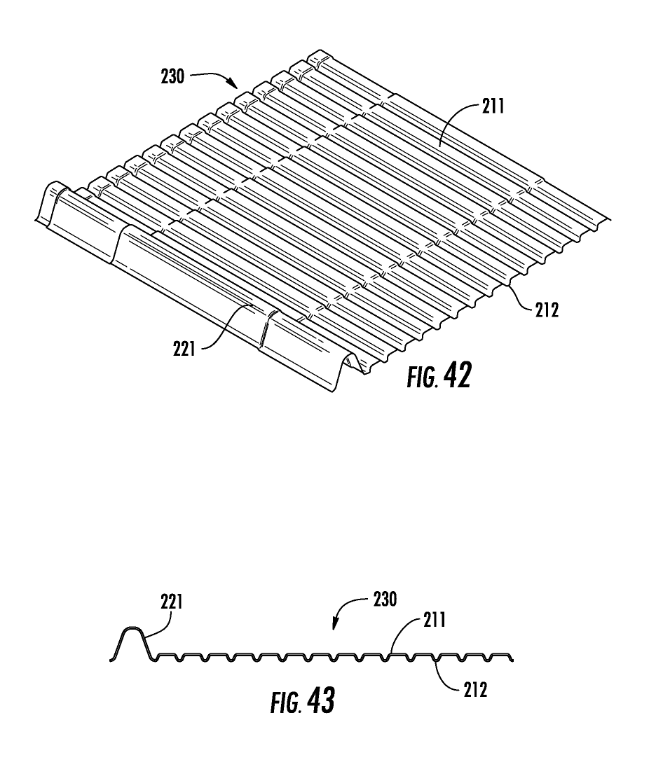

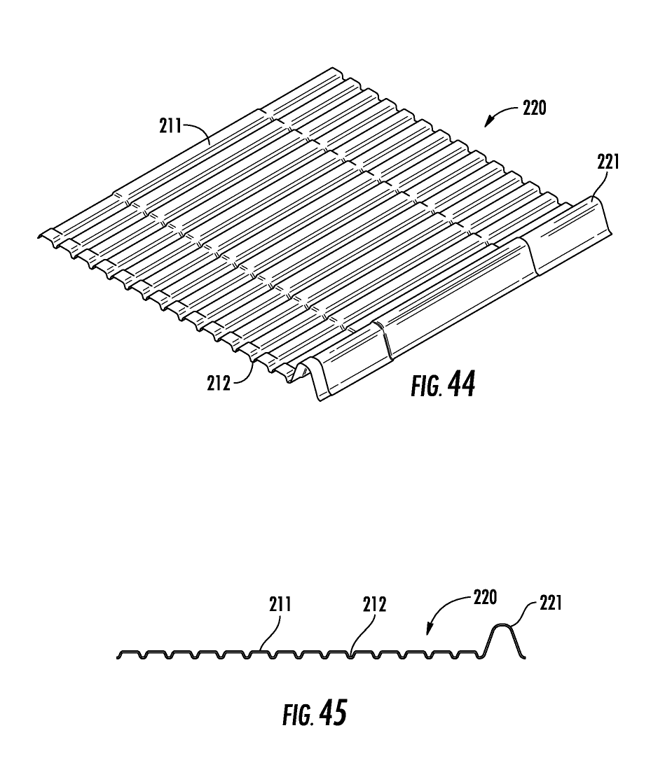

FIGS. 34-37 show an exemplary embodiment of a left upstream corner panel 180. In various exemplary embodiments, left upstream corner panel 180 is generally rectangular in shape and corrugated with an edge portion having alternating flat ribs and narrow valleys substantially matching body panel 110. Left upstream corner panel 180 also comprises a continuous raised perimeter rib 121 along its top edge and left edge.

FIGS. 38-41 show an exemplary embodiment of a left downstream corner panel 190. In various exemplary embodiments, a left downstream corner panel 190 is generally rectangular in shape and corrugated with an edge portion having alternating flat ribs and narrow valleys substantially like body panel 110. Left downstream corner panel 190 also comprises a continuous raised perimeter rib 121 along its bottom edge and left edge.

It should be noted that although the right upstream corner panel 160, right downstream corner panel 170, left upstream corner panel 180, and a left downstream corner panel 190 are named and described in connection for their use on an outside corner (90° of pad), variations thereof may also be molded for use on inside corners (270° of pad) by forming ribs and valleys on exterior sides of continuous, angled perimeter ribs 121 in an obvious manner. Thus, it should also be noted that although the lining system is shown herein as rectangular in shape, more complex shapes may be assembled using the disclosed systems and methods within the meaning of the appended claims.

FIGS. 42 and 43 show an exemplary embodiment of a right perimeter panel 230. In various exemplary embodiments, a right perimeter panel 230 is generally rectangular in shape and corrugated with alternating flat ribs 111 and narrow valleys 112 substantially matching the corrugations of body panel 110. In various exemplary embodiments, a right perimeter panel 230 also comprises a raised perimeter rib 221 along its right edge. In various exemplary embodiments, a right perimeter panel 230 is attachable to a body panel 110 by overlapping flat rib 211 of a right perimeter panel 230 and the rightmost rib 111 of a body panel 110, preferably with a gasket or other sealant placed between the two components. In various exemplary embodiments, a right perimeter panel 230 is substantially similar to the right perimeter section 130 except for the increased number of ribs 211 and valleys 212 across the width of the panel.

FIGS. 44 and 45 show an exemplary embodiment of a left perimeter panel 220. In various exemplary embodiments, a left perimeter panel 220 is generally rectangular in shape and corrugated with alternating flat ribs 111 and narrow valleys 112 substantially matching the corrugations of body panel 110. In various exemplary embodiments, a left perimeter panel 220 also comprises a raised perimeter rib 221 along its left edge. In various exemplary embodiments, a left perimeter panel 220 is attachable to a body panel 110 by overlapping flat rib 211 of a left perimeter section 220 and the leftmost rib 111 of the body panel 110, preferably with a gasket or other sealant placed between the two components. In various exemplary embodiments, a left perimeter panel 220 is substantially similar to the left perimeter section 120 except for the increased number of ribs 211 and valleys 212.

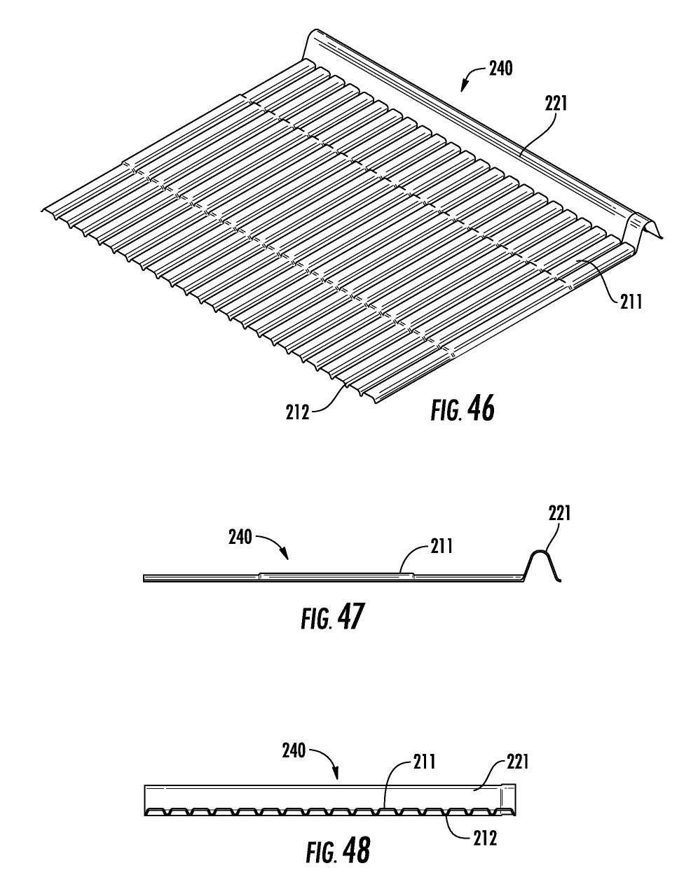

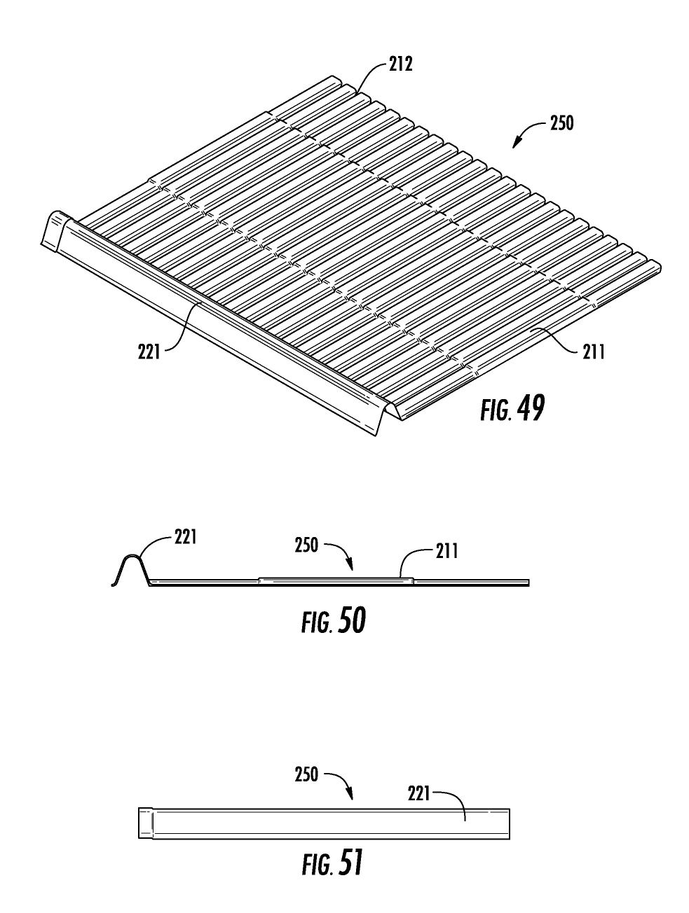

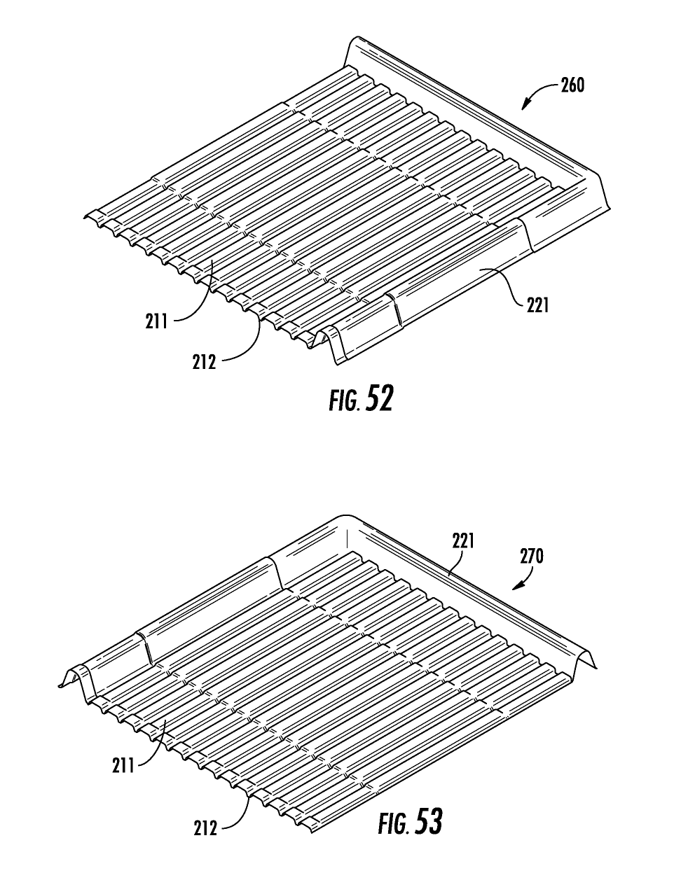

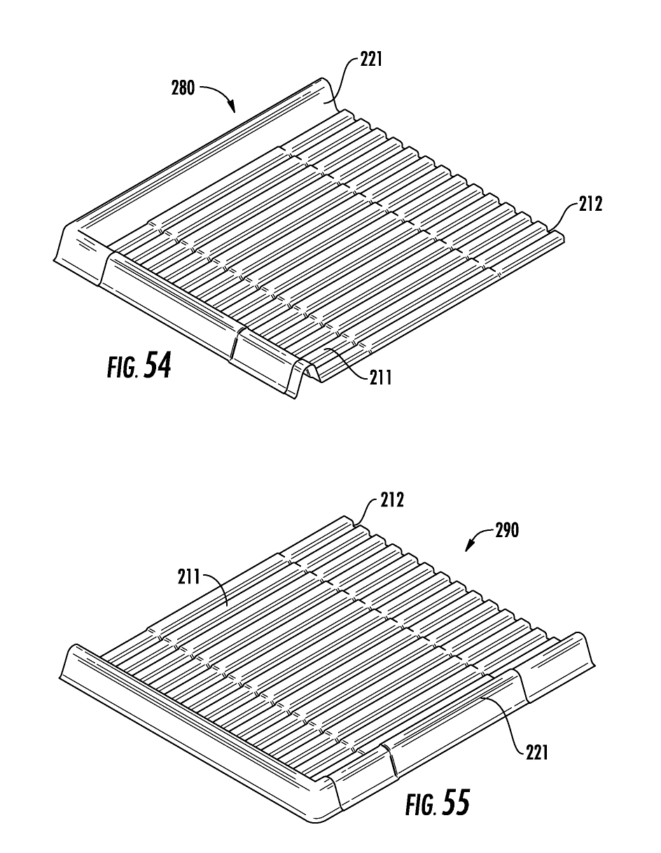

FIGS. 46-48 show an exemplary embodiment of an upstream perimeter panel 240. In various exemplary embodiments, upstream perimeter panel 240 is generally rectangular in shape and corrugated with alternating short flat ribs 111 and narrow valleys 112 substantially matching the corrugations of body panel 110. In various exemplary embodiments, an upstream perimeter panel 240 also comprises a raised perimeter rib 221 along its top edge. In various exemplary embodiments, an upstream perimeter panel 240 is attachable to a body panel 110 by overlapping the short flat ribs 111 and valleys 112 of the upstream perimeter panel 240 and the ribs 111 and valleys 112 at the upper edge of the body panel 110, preferably with a gasket or other sealant placed between the two components. In various exemplary embodiments, the upstream perimeter panel 240 is substantially similar to the upstream perimeter section 140 except for the increased length of the ribs 211 and valleys 212, extending downstream from the raised perimeter rib 221.

FIGS. 49-51 show an exemplary embodiment of a downstream perimeter panel 250. In various exemplary embodiments, downstream perimeter panel 250 is generally rectangular in shape and corrugated with alternating flat ribs and narrow valleys substantially matching the corrugations of body panel 110. In various exemplary embodiments, a downstream perimeter panel 250 also comprises a raised perimeter rib 221 along its bottom edge. In various exemplary embodiments, a downstream perimeter panel 250 is attachable to a body panel 110 by overlapping the short flat ribs 211 and valleys 212 of the downstream perimeter panel 250 with the ribs 111 and valleys 112 at the lower edge of the body panel 110, preferably with a gasket or other sealant placed between the two components. In various exemplary embodiments, the downstream perimeter panel 250 is substantially similar to the downstream perimeter section 150 except for the increased length of the ribs 211 and valleys 212.

FIG. 52 shows an exemplary embodiment of a right upstream corner panel 260. In various exemplary embodiments, right upstream corner panel 260 is generally rectangular in shape and corrugated with alternating flat ribs 211 and narrow valleys 212 substantially matching the corrugations of body panel 110. Right upstream corner panel 260 also comprises a continuous raised perimeter rib 221 along its upstream edge and right edge. In various exemplary embodiments, the right upstream corner panel 260 is substantially similar to the right upstream corner section 160 except for overall size and the number and length of ribs 211 and valleys 212.

FIG. 53 shows an exemplary embodiment of a left upstream corner panel 270. In various exemplary embodiments, left upstream corner panel 270 is generally rectangular in shape and corrugated with alternating flat ribs 211 and narrow valleys 212 substantially matching the corrugations of body panel 110. Left upstream corner panel 270 also comprises a continuous raised perimeter rib 221 along its top edge and left edge. In various exemplary embodiments, the left upstream corner panel 270 is substantially similar to the left downstream corner section 170 except for overall size and the number and length of ribs 211 and valleys 212.

FIG. 54 shows an exemplary embodiment of a left downstream corner panel 280. In various exemplary embodiments, left downstream corner panel 280 is generally rectangular in shape and corrugated with alternating flat ribs and narrow valleys substantially matching the corrugations of body panel 110. Left downstream corner panel 280 also comprises a continuous raised perimeter rib 221 along its downstream edge and left edge. In various exemplary embodiments, the left downstream corner panel 280 is substantially similar to the left downstream corner section 180 except for overall size and the number and length of ribs 211 and valleys 212.

FIG. 55 shows an exemplary embodiment of a right downstream corner panel 290. In various exemplary embodiments, right downstream corner panel 290 is generally rectangular in shape and corrugated with alternating flat ribs and narrow valleys substantially like body panel 110. Right corner panel 290 also comprises a continuous raised perimeter rib 221 along its downstream edge and right edge. In various exemplary embodiments, the right downstream corner panel 290 is substantially similar to the right downstream corner section 190 except for overall size and the number and length of ribs 211 and valleys 212.

In various exemplary embodiments, the perimeter rib 121 or 221 is taller than the ribs 112 and 113. In one exemplary embodiment, the perimeter rib 121 or 221 is about 4 inches tall and 6 inches wide at the base. In other exemplary embodiments, the perimeter ribs 121 or 221, or portions of them, may be of greater height, such as 7 to 10 inches, or greater, depending on containment needs. Depending upon the height of ribs 121 or 221, it may be advantageous and practical in some areas, particularly for upstream perimeter panels 240, to facilitate vehicle entry points on the gravel pad 101 when passing over the perimeter edge of the lining system 100, by removing portions of the peripheral ribs 121 or 221. In various exemplary embodiments, the panels 110 are installed such that the predominant downstream direction of flow is generally parallel to the ribs 111 but more complicated flow patterns may include flows in different directions.

In various exemplary embodiments, one or both of the ribs 111 at an edge of a body panel 110 or other components 120, 130, 140, 150, 160, 170, 180, 190, 220, 230, 240, 250, 260, 270, 280, or 290 may be offset to facilitate overlapping connection of panels. In various exemplary embodiments, the offset rib is larger or smaller than standard rib 111 by about the thickness of the component material (e.g., 0.075 inches) so that it will fit closely with rib 111. In some exemplary embodiments, more than one offset rib may be provided to facilitate reuse of the component.

In various exemplary embodiments, all of the components 110, 120, 130, 140, 150, 160, 170, 180, and 190 and/or 220, 230, 240, 250, 260, 270, 280, and 290 may be produced using a single mold. For example, the mold may be designed to produce a panel with a perimeter rib 121 around its entire perimeter. Such a part may then be trimmed to form one or more desired components. Alternatively, by way of example, inserts may be placed in the mold to selectively reduce the mold to form a selected component with or without a perimeter rib on selected side(s) and with selected shape and dimensions. The liner components are preferably and typically formed from a recyclable thermoplastic material, such as HDPE, particularly if part of the liner component is to be removed so that the trimmed or removed portion may be shredded, reheated, reformed, and thereby recycled back in to the production process. In various exemplary embodiments, the panel 110 includes molded-in trim guides to assist in removing scrap sheet. The panels may be trimmed with a cutting tool such as, for example, a router or a circular saw.

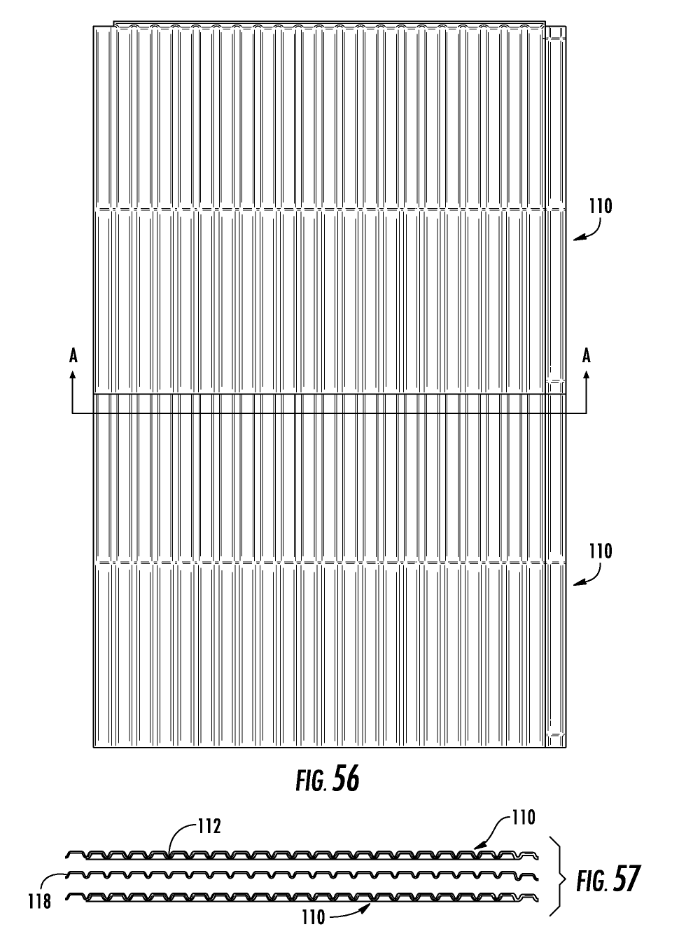

FIGS. 56 and 57 illustrate an overlapping end-to-end connection of two body panels 110. In various exemplary embodiments, the downstream end of one panel 110 is aligned over the upstream end of a second panel 110 for end-to-end coupling of panels 110. In various exemplary embodiments, a liquid-tight or leak-resistant connection is obtained by placing a gasket 118 or other sealant between the overlapped panels 110. Fasteners (not shown in FIGS. 56 and 57), such as, for example, self-tapping screws, may be used to securely couple the liner panels 110. In various exemplary embodiments, the fastener is preferably installed in the bottom of the crevice 112 between two ribs 111.

FIGS. 58-60 illustrate an overlapping side-to-side connection of four body panels 110 (two sets of the connected body panels 110 shown in FIGS. 56 and 57). As shown in FIG. 59, the ribs 111 to the rightmost edge of panels 110 are overlapped with the ribs 111 to the leftmost edge of other panels 110. In various exemplary embodiments, a seal or gasket 118 placed between the panels 110 to provide a liquid tight or leak resistant connection. Although the body panels 110 to the left are shown above the panels 110 to the right, either panel 110 may be placed above or below the other.

FIGS. 61 and 62 illustrate an overlapping connection of four panels 110 at their respective corners 113, 114, 115, and 116 (see FIGS. 5 and 6). In various exemplary embodiments, as shown in FIGS. 5 and 6, the upstream right corner 113 and the downstream right corner 114 of a body panel 110 are offset to facilitate connections. In various exemplary embodiments, as shown in FIG. 62, taken along section line the four corners 113, 114, 115, and 116 are overlapped with upstream right corner 113 as the lowest component. A downstream right corner 114 is placed above corner 113 with gasket 118 between. An upstream left corner 115 is placed above corner 114 with gasket 118 between. A downstream left corner 116 is placed above corner 115 with a gasket 118 between. As shown in FIG. 60, in various exemplary embodiments, the gaskets 118 extend along the entire junction of any two overlapped panels 110. In various exemplary embodiments, where the offset corners 113 and 114 are reduced and/or lowered corners, such as shown in the figures, they are placed below the non-offset corners. In various other exemplary embodiments, raised or enlarged offset corners may be provided and would be adapted for connection above non-offset corners.

In various exemplary embodiments, other components 120, 130, 140, 150, 160, 170, 180, 190, 220, 230, 240, 250, 260, 270, 280, or 290 connect with body panel 110 and each other in substantially the same manner as described above for multiple body panels 110.

In various exemplary embodiments, as shown in FIGS. 63 and 64, the containment lining system 100 may include a plurality of interconnected main panels 110 in a level installation with connected sections providing a continuous perimeter rib 121 extending substantially around the periphery of the lining system 100 for effective containment of fluid contaminants. The system panels may be connected with each other as previously described, or may be connected by plasma welding as shown in the exemplary embodiment of FIG. 65 and disclosed in more detail below. The lining system 100 is supported on subsurface aggregate 90 which is shown to have been graded substantially level, but could also be slightly sloped as desired. A plurality of load bearing mats 300 are shown extending across the surface of the liner body panels 110 for the purpose of supporting operating equipment and wheeled vehicles (not shown.) Gravel bridges 310 are schematically shown for bearing the vehicles over the perimeter rib 121 and onto the mats 300 without damage to the structure of the rib 121. Alternatively, or additionally, suitable structural bridges may be constructed over the rib for the same purpose and for personnel walkways and the like. Main liner panels 110, which may be corrugated or flat planar HDPE panels, as previously described, are both well suited for bearing the distributed loads transferred by the mats 300. The mats 300 can be selected from SteelLock Interlocking Mats, WebLock® Composite Mats and WorkSafe Rig Mats being currently offered commercially by Strad Engineering Services, of Denver, Colo., and Fibergrate molded grating mats and other grating products being currently offered commercially by Fibergrate of Dallas, Tex. Other suitable load bearing matting currently being marketed or which may be manufactured and marketed in the future can effectively be employed on the lining system.

FIG. 64 shows an exemplar containment lining system 100 in which flat planar thermoplastic HDPE body liner panels 110 are connected by plasma welding, as schematically shown in FIG. 65 and described below. A storage tank 320 for containing liquid as shown is supported on the lining system 100. The tank 320 may additionally be supported by a gravel pad or load bearing mats placed on top of the main body panels 110 as described above. Additionally, any working surface or area of the main body panels of the containment lining system 100 of FIG. 64 surrounding or adjacent to the liquid storage tank 320 may additionally be covered by a load bearing surface such as gravel or load bearing mats (not shown in FIG. 64) as desired. A peripheral rib or wall 320 of sufficient height to contain the liquid contents of the storage tank 320 and other possible water or industrial fluids which might leak or spill onto the liners system is shown in two configurations. In one configuration, a large formed plastic rib 330 which is similar to the perimeter ribs previously shown, but larger, is connected to the main body of the liner about its periphery in fluid-tight relation, such as by plasma welding. In another configuration, an angled outer wall 340 may be laid up on and supported by a gravel or earthen birm 350 constructed around all or part of the containment system. Where the main body connected panels 110 are flat and may be sheet extruded in greater lengths and supplied in roll form, the extruded sheets 110 may be rolled out to the top of the birm 350 and connected together by plasma welding in fluid-tight relation to provide an impermeable wall 340 as shown on the right side of FIG. 64.

FIG. 65 shows a schematic illustration of a pair of overlapping HDPE or other suitable thermoplastic sheet materials suitable for comprising the described lining system 100, and the connected described components thereof, positioned for electrofusion plasma welding. A pair of spaced Powercore welding rod sections 380, available from Powercore International, Ltd., of Ottawa, Ontario, Canada, are placed between the overlapped HDPE sheets 360 and 370. The thermoplastic welding rod sections 380 include electrical conductors and conductive end terminals 390. When in place, an electrical current is run through the welding rods for a controlled period to heat the thermoplastic material of the welding rod and the two opposed sheets to fuse the two sheets together and form strong structural thermoplastic welded bonds between the two sheets which are impermeable to liquids.

An alternative embodiment of the lining system 400 is illustrated in FIGS. 66-79. The lining system 400 includes features which are substantially as described herein in association with lining system 100. Operation, particular components, and materials described herein are substantially the same and like numbers have been used to illustrate the like components. In this embodiment, the lining system 400 includes a plurality of panels 410. FIGS. 66 and 67 illustrate an individual panel 410. Panel 410 may include a plurality of corrugations having alternating ribs 111 and valleys 112. An edge portion 419 may be provided between the corrugations and the outer perimeter of panel 410. Generally, edge portion 419 has a height which is less than the height of the corrugations. Panel 410 may be generally rectangular in shape. However, in one or more exemplary embodiments, panel 410 may be any suitable or desired shape. In one or more exemplary embodiments, ribs 111 may have a height of about 1.0 inch tall, and may have a width of about 4.0 inches wide (as measured between the bottoms of adjacent valleys 112). In one or more exemplary embodiments, side walls of ribs 111 may be angled or sloped at about 25 degrees from vertical, however the sidewall angle may be varied. It should be noted that size and shape of the ribs may vary within the scope of the present disclosure and claims to meet the design needs of the targeted user group. Further, in one or more exemplary embodiments, panel 410 may not include any corrugations. While the corrugated pattern provides greater strength and rigidity to body panels 410 and other components, in certain applications of lining system 400, corrugations may not be desirable.

In various exemplary embodiments, body panel 410 may be about 100 inches long (i.e., the dimension perpendicular to ribs 111) and about 75 inches wide (i.e., the dimension parallel to ribs 111). In various exemplary embodiments, body panel 410 corrugations are about 1.15 inches high. In various exemplary embodiments, valleys 112 are approximately 4.16 inches apart (i.e., distance between the bottom points of adjacent valleys) and the sides of the valleys 112 are inclined at an angle of about 115.00 degrees from horizontal (at the base). In various exemplary embodiments, the panels will be formed from HDPE sheets having a thickness ranging between 0.060 to 0.300 inches, and more specifically between 0.080 to 0.250 inches, and more specifically approximately 0.170 inches. However, in one or more examples of embodiments, thinner or thicker sheet materials may be used depending upon the application, required useful panel life, or conditions of use.

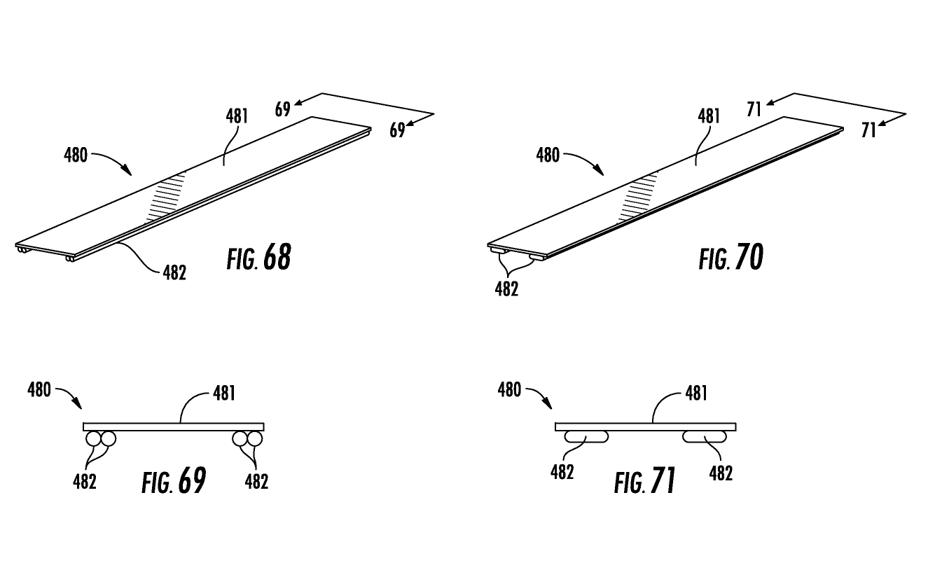

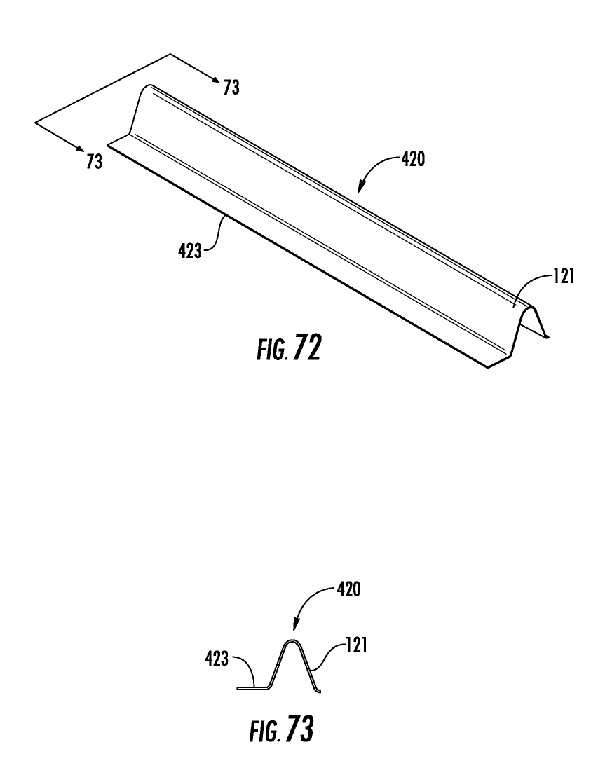

FIGS. 68 to 69 illustrate one or more embodiments of a sheet coupling assembly 480. Sheet coupling assembly 480 is adapted to couple separate body panels 410 through a thermoplastic weld. Sheet coupling assembly 480 may include a bridge connecting strip 481 having a plurality of weld rods 482 provided on one side. As illustrated in FIGS. 68 and 69, two pairs of weld rods 482 extend approximately parallel to each other along one side of the bridge strip 481. The tubular weld rods 482 have a generally circular cross sectional shape.

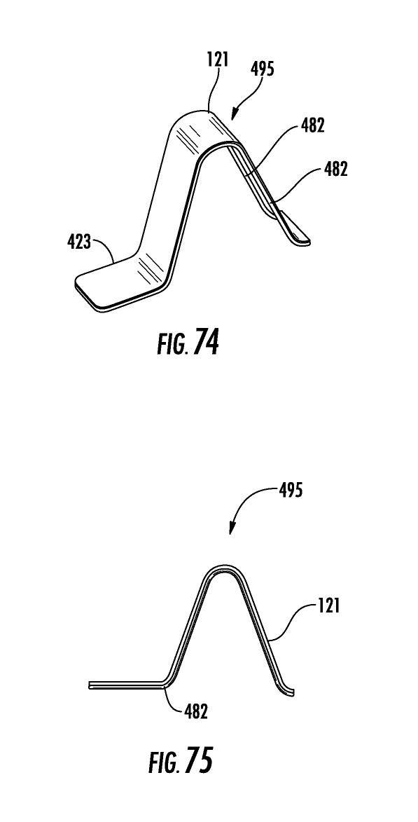

FIGS. 70 and 71 illustrate one or more examples of additional embodiments of sheet coupling assembly 480. In this embodiment, two tubular weld rods 482 are provided on one side of bridge strip 481 and extend approximately parallel to each other. The rods 482 have a generally oval cross sectional shape and larger surface area than each of the weld rods illustrated in FIGS. 68-69.

Weld rods 482 may be a flexible elongate thermoplastic material embedded with one or more resistance wires similar to those comprising terminals 390 in FIG. 65 that extend substantially coaxially with the elongate thermoplastic material. Weld rods 482 are suitable for welding together two separate thermoplastic materials. One suitable flexible thermoplastic weld rod 482 for use in accordance with the disclosed embodiments is a Powercore Welding Rod available from Powercore International, Ltd. of Ottawa, Ontario, Canada. The thermoplastic material used for the weld rods 482 may be selected to match the material of the body panels 410, perimeter sections 420, and/or corner perimeter sections 460, for example HDPE, or may be selected of a compatible material separate from the body panels 410, perimeter sections 420, and/or corner perimeter sections 460, for example linear low-density polyethylene (LLDPE).

In one or more examples of embodiments, sheet coupling assembly 480 may be any length and/or width suitable for coupling two or more separate body panels 410 together by a thermoplastic weld. Further, bridge strip 481 may have a thickness ranging between 0.030 to 0.120 inches, and more specifically between 0.050 to 0.100 inches, and more specifically approximately 0.080 inches. However, in one or more examples of embodiments, thinner or thicker sheet materials may be used depending upon the application, required useful weld life, or conditions of use.

FIGS. 72 and 73 illustrate one or more examples of embodiments of a perimeter panel section or side wall 420. Perimeter panel 420 may include a raised perimeter rib 121 coupled to an edge portion 423. Lip portion 423 may correspond to and be adapted to engage edge portion 419 of one or more panels 410. More specifically, one or more perimeter panels 420 may be provided about the outer perimeter of lining system 400 to provide peripheral containment of materials within lining system 400.

In one or more examples of embodiments, perimeter panel 420 may be formed strips of any length and/or width suitable for providing peripheral containment of certain materials within lining system 400. In addition, raised perimeter rib 121 of perimeter panel 420 may be any height suitable for providing peripheral containment of certain materials within lining system 400. Perimeter panel 420 may have a thickness ranging between 0.060 to 0.300 inches, and more specifically between 0.080 to 0.250 inches, and more specifically approximately 0.170 inches. However, in one or more examples of embodiments, thinner or thicker sheet materials may be used depending upon the application, required useful panel life, or conditions of use. Perimeter panel 420 may be manufactured of similar materials and using similar manufacturing processes as body panels 410.

FIGS. 74 and 75 illustrate one or more examples of embodiments of a perimeter panel coupling assembly or side wall coupling assembly 495. Perimeter panel coupling assembly 495 may include a raised formed perimeter rib 121 coupled to an edge portion 423. The raised perimeter rib 121 and edge portion 423 generally have dimensions which correspond to the raised perimeter rib 121 and edge portion 423 of perimeter panel 420. Perimeter panel coupling assembly 495 has a width generally smaller than the width of perimeter panel 420 and serves as a bridge or connecting strip between perimeter panels 420 and 460. In addition, perimeter section coupling assembly 495 includes a plurality of weld rods 482 provided on one side. As illustrated in FIGS. 74 and 75, at least one or more tubular weld rods 482 extend around a portion of the under surface of coupling assembly 495 to engage and weld the perimeter panel 420 to matching surfaces of adjacent perimeter panels 420.

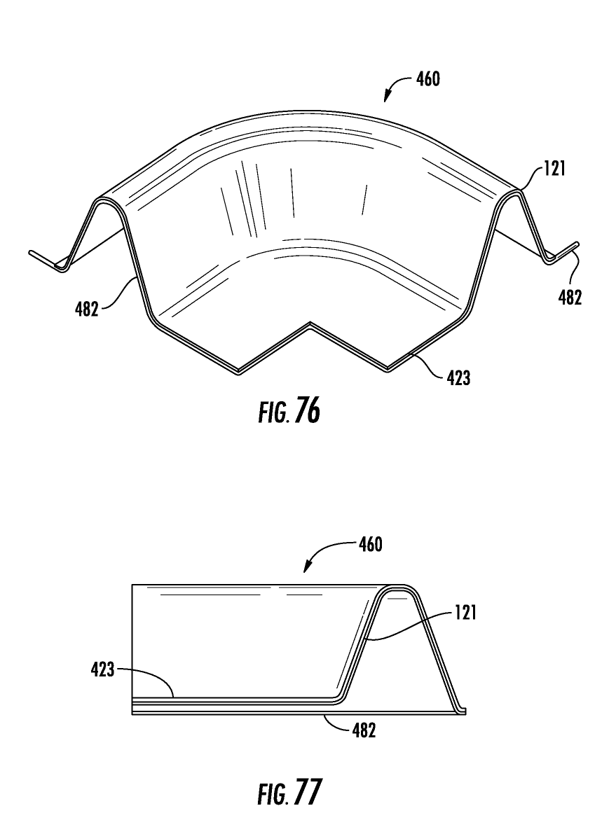

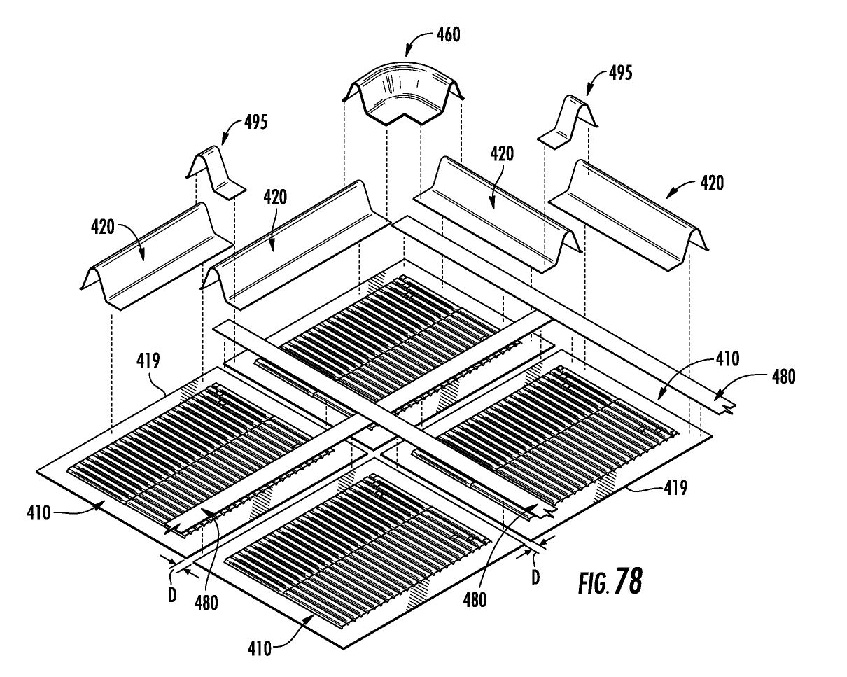

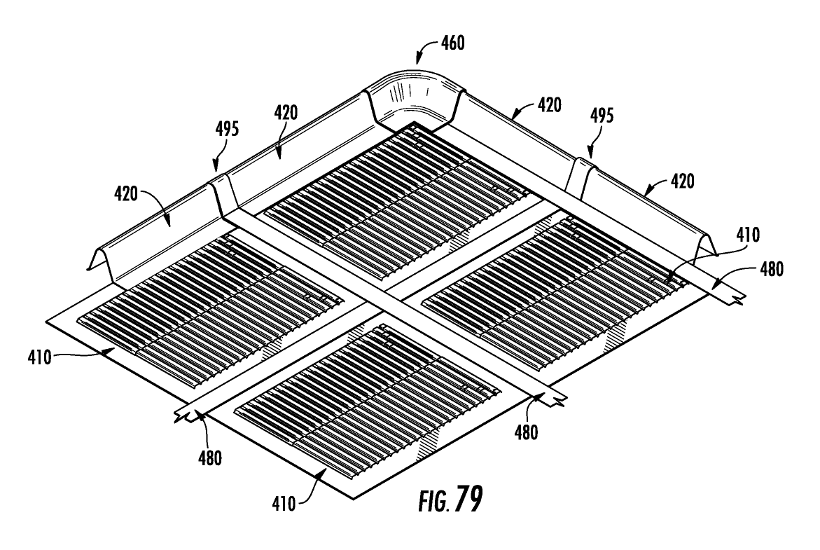

FIGS. 76 and 77 illustrate one or more examples of embodiments of a corner perimeter panel 460. Corner perimeter panel 460 may include a continuous raised perimeter rib 121 which includes an approximate arcuate portion to form an “angle” of the containment system peripheral wall. An edge portion 423 may be coupled to rib 121. Edge portion 423 may correspond to and be adapted to engage edge portion 419 of a panel 410. More specifically, corner perimeter panel 460 may be provided in one or more corners along the outer perimeter of lining system 400 to assist in providing peripheral containment of materials within lining system 400. In one or more examples of embodiments, corner perimeter panel 460 may be manufactured of similar materials and using similar manufacturing processes as body panels 410 and/or perimeter panels 420. In addition, corner perimeter panel 460 may have similar heights and/or thicknesses as perimeter panels 420.

As illustrated in FIGS. 76 and 77, corner perimeter panel 460 includes a plurality of weld rods 482 provided on one side. More specifically, tubular weld rod 482 may extend around a portion of the under surface of corner perimeter panel 460, including the under surface of continuous raised perimeter rib 121 and edge portion 423.

FIGS. 78 and 79 illustrate a portion of lining system 400. The illustrated portion of lining system 400 includes an outer perimeter corner of the lining system 400. It should be appreciated that the illustrated components of lining system 400 are for illustration only and include only a portion of the components necessary for a complete lining system 400. Additional panels 410, perimeter panels 420, corner perimeter panels 460, sheet coupling assemblies 480, and/or perimeter panel coupling assemblies 495 would be necessary to form a complete lining system.

Referring to FIGS. 78 and 79, a plurality of body panels 410 are illustrated being coupled to one another by a plurality of sheet coupling assemblies 480. Additional panels 410 not shown may be provided, extending at the edge portions of illustrated panels 410 furthest away from illustrated corner perimeter panel 460. The sheet coupling assemblies 480 are coupled to a plurality of consecutive panels 410 along associated edge portions 419. As shown in FIG. 78, the sheet coupling assemblies 480 are aligned to overlap portions of edge portions 419 in order to seal any gaps between consecutive body panels 410. Referring specifically to FIG. 79, the sheet coupling assemblies 480 are illustrated as engaged and welded to portions of edge portions 419 of consecutive panels 410, coupling the consecutive panels 410 to one another. The weld rods 482 of sheet coupling assemblies 480 will interact with the thermoplastic material of edge portions 419 of adjacent panels 410, forming a liquid tight weld and/or seal between panels 410. It should be appreciated that the body panels 410 illustrated in FIGS. 78 and 79 are spaced a distance D from each other. Distance D is illustrated as a distance between consecutive panels 410. Effectively, distance D illustrates a seam between body panels 410. Distance D may be any suitable distance to allow for the panels to be coupled by sheet coupling assembly 480 and provide for the suitable and/or desired containment lining characteristics as disclosed herein. In one or more examples of embodiments, distance D may be zero in that body panels 410 contact each other along the respective edge portions or perimeter portions of panels 410. In addition, it should be appreciated that sheet coupling assembly 480 may couple a plurality of panels 410 along two or more of the outer edge portions or outer perimeter portions of lining system 400. This allows for a plurality of panels 410 to be coupled together in a liquid tight manner to form lining system 400 of the desired size.

FIGS. 78 and 79 also illustrate a plurality of perimeter panels 420 coupled to lining system 400. More specifically, perimeter panels 420 are consecutively provided about the outer perimeter of lining system 400. More specifically, edge portions 423 of perimeter panels 420 are consecutively provided about and coupled to edge portions 419 of body panels 410 corresponding to the outer perimeter of lining system 400. The weld rods 482 of perimeter sections 420 will interact with the thermoplastic material of edge portions 419 of panels 410, forming a liquid tight weld and/or seal with edge portions 419 of panels 410.

In addition, consecutive perimeter panels 420 may be coupled together by perimeter section coupling assemblies 495. Perimeter panel coupling assemblies 495 may receive a portion of consecutive perimeter panels 420, for example in the bottom or under side, overlapping portions of consecutive perimeter panels 420. In addition, edge portion 423 of perimeter panel coupling assembly 495 may overlap edge portions 423 of perimeter panels 420, and portions of body panel edge portions 419. As such, weld rods 482 of perimeter panel coupling assemblies 495 will interact with the thermoplastic material of perimeter panels 420 and edge portions 419 of body panels 410, forming a liquid tight weld and/or seal between perimeter panel coupling assemblies 495 and the coupled perimeter panels 420 and edge portions 419 of body panels 410.

It should be appreciated in one or more examples of embodiments, consecutive perimeter panels 420 may have a distance there between. Effectively, the distance illustrates a potential seam between perimeter panels 420. The distance may be any suitable distance to allow for the panels to be coupled by perimeter panels coupling assemblies 495 and provide for the suitable and/or desired containment lining characteristics as disclosed herein. In one or more examples of embodiments, distance D may be zero in that perimeter panels 420 contact each other along the respective edge portions of perimeter panels 420.

FIGS. 78 and 79 also illustrate a corner perimeter panel 460 coupled to lining system 400. More specifically, corner perimeter panel 460 is provided in a corner of the outer perimeter of lining system 400. More specifically, corner perimeter panel 460 is provided about and coupled to edge portions 419 in a corner of body panel 410 corresponding to the outer perimeter corner of lining system 400. The weld rods 482 of corner perimeter panel 460, including edge 423, will interact with the thermoplastic material of edge portions 419 of panels 410, forming a liquid tight weld and/or seal between corner perimeter panel 460 edge portions 423 and panels 410.

In addition, corner perimeter panel 460 may be coupled to adjacent perimeter panels 420. Corner perimeter panel 460 may receive a portion of bordering perimeter panels 420, for example in the bottom or under side, thus overlapping portions of bordering perimeter panels 420. Weld rods 482 providing on corner perimeter panel 460 will interact with the thermoplastic material of perimeter panels 420, forming a liquid tight weld and/or seal between corner perimeter panel 460 and bordering perimeter panels 420.

In addition, referring to FIGS. 78 and 79, sheet coupling assemblies 480 may be provided over top of portions of perimeter panels 420 and perimeter panel coupling assemblies 495, for example over the edge portions 423. The sheet coupling assemblies 480 will overlap a portion of perimeter panels 420 and perimeter panel coupling assemblies 495 and edge portions 419 of body panels 410. This allows weld rods 482 of sheet coupling assemblies 480 to interact with thermoplastic material of perimeter panels 420, perimeter panel coupling assemblies 495, and edge portions 419 of body panels 410, forming a liquid tight weld and/or seal between the perimeter panels 420, perimeter panel coupling assemblies 495, and edge portions 419 of panels 410. It should be appreciated in one or more embodiments that sheet coupling assemblies 480 may be provided either over top or underneath portions of corner perimeter panels 460, depending upon various desired factors, including, but not limited to, the liquid tight weld and/or seal desired.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “upstream,” “downstream,” “left,” and “right”) in this description are merely used to identify various elements as are oriented in a typical installed system. It should be recognized that the orientation of particular panels may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be appreciated that the construction and arrangement of the site pad lining system, as shown in the various exemplary embodiments, is illustrative only. While the site pad lining system, according to this invention, has been described in conjunction with the exemplary embodiments outlined above, various alternatives, modifications, variations, improvements, and/or substantial equivalents, whether known or that are or may be presently unforeseen, may become apparent. Accordingly, the exemplary embodiments of the site pad lining system, according to this invention, as set forth above, are intended to be illustrative, not limiting. Various changes may be made without departing from the spirit and scope of the invention. Therefore, the description provided above is intended to embrace all known or later-developed alternatives, modifications, variations, improvements, and/or substantial equivalents.

What is claimed is:

1. A modular, scalable containment lining system for an industrial site comprising:
a plurality of connectable formed thermoplastic liner components having an upstream edge portion, a downstream edge portion, a right side edge portion, and a left side edge portion, the said components further comprising:
a plurality of liner body panels:
wherein the body panels are formed for substantially liquid-tight connection of said body panels between an upstream edge portion of a body panel and a matching downstream edge portion of another body panel; and
wherein the body panels are further formed for substantially liquid-tight connection of body panels between a left side edge portion of one body panel and a matching right side edge portion of another body panel;
a plurality of perimeter panels each formed for substantially liquid-tight connection to a body panel, said perimeter panels each having an edge portion selectively formed to conform to at least one of a matching upstream edge portion, downstream edge portion, right side edge portion or left side edge portion of a body panel, each said perimeter panel additionally having a raised perimeter edge rib portion with ends formed for substantially liquid-tight connection to a matching end of another perimeter panel such that the perimeter panels may be selectively connected with matching edge portions of body panels and other perimeter panels in liquid-tight relation to form a substantially continuous raised perimeter edge rib extending completely around an assembly of body panels continuously connected in liquid-tight relation

2. The modular, scalable containment lining system of claim 1 wherein the mating edges of the body panels are assembled and connected in substantially liquid-tight relation by connecting the respective matching upstream and downstream edge portions and connecting the respective left side edge portions and right side edge portions of the body panels to form a tough, continuous, load supporting substantially liquid-tight thermoplastic liner body extending across a prepared subsurface of the industrial site; and
wherein the matching edges of the perimeter panels are assembled and connected in substantially liquid-tight relation to matching edges of the assembled body panels, and the raised perimeter edge rib portions of the perimeter panels are connected in substantially liquid-tight relation to matching selected raised perimeter edge rib portions of other perimeter panels, to form a continuous raised perimeter edge rib extending substantially around the assembly of body panels and connected thereto to form a tough, continuous, substantially liquid-tight container lining system capable of containing liquid materials leaked or discharged to or otherwise received within the confines of the containment lining system.

3. The modular, scalable containment lining system of claim 2 wherein the components are connected in substantially liquid-tight relation by at least one of:
adhesive bonding of overlapping matching portions of the assembled component panels:
mechanical connection of overlapping matching portions of the assembled component panels with compressed gasket and/or sealant material interbedded between overlapping connected portions;
electrofusion plasma welding of overlapping matching portions of the assembled component panels;
and electrofusion plasma welding of compatible thermoplastic connecting strips to each of adjacent matching portions of the assembled component panels.

4. The modular, scalable containment lining system of claim 1,
wherein the perimeter panels include straight perimeter panels and corner perimeter panels, and
wherein the straight perimeter panels have substantially straight raised perimeter rib portions and edge portions formed for matching and connecting to at least one of the said upstream edge portions, downstream edge portions, left side edge portions and right side edge portions of the body panels, and
wherein the corner perimeter panels each have angled raised perimeter rib portions and edge portions formed for matching and connecting to at least one of the corners of the body panels which may each comprise two of the said upstream edge portions, downstream edge portions, left side edge portions and right side edge portions of the body panels.

5. The modular, scalable containment lining system of claim 1,
wherein the body panels each comprise a plastic sheet formed to define a plurality of corrugations comprising alternating ribs and valleys extending perpendicular to and between the upstream ends and the downstream ends of the body panels to thereby define upstream and downstream panel edge portions having a corrugated surface, and
wherein the edge portions of the perimeter panels which are formed to match any portion of the corrugated upstream edges or downstream edges of the body panels will have similar corrugations to provide a close overlapping fit between the body panel corrugated edge portions and the perimeter panel matching edge portions.

6. The modular, scalable containment lining system of claim 1,
wherein the body panels each comprise a plastic sheet formed to define a plurality of corrugations comprising alternating ribs and valleys extending perpendicularly between the upstream and downstream edge portions of the body panels, and further define a planar surface extending around the periphery of the panel to provide planar edge portions on all sides of the panels, and wherein the edge portions of the perimeter panels which conform to and match the edge portions of the body panels for connection thereto are likewise planar.

7. The modular, scalable containment lining system of claim 1,
wherein the body panels each comprise a planar extruded thermoplastic sheet having planar edge portions for connection to matching planar edge portions of the perimeter panels, and
wherein the body panels may comprise individual cut sheets or extended length sheets which are adapted for storage and shipment in roll form for roll out and assembly on the job site to minimize the time and expense of connecting upstream and downstream end portions of shorter individual cut sheets.

8. The modular, scalable containment lining system of claim 1 further comprising a drainage outlet in fluid communication with the upper surface of the main body of the containment lining system.

9. The modular, scalable containment lining system of claim 1,
wherein the containment liner components further comprise at least one cutting line located proximate to the area of connection of the liner components to facilitate removal of a part of an edge portion.

10. The modular, scalable containment lining system of claim 1,
wherein the thermoplastic liner body panels are formed by extrusion, or by extrusion and thermoforming.

11. The modular, scalable containment lining system of claim 1, wherein the thermoplastic perimeter panels are formed by extrusion and thermoforming.

12. A method of assembling a modular, scalable containment liner for an industrial site, comprising:
providing a plurality of connectable formed thermoplastic liner components each having an upstream edge portion, a downstream edge portion, a right side edge portion and a left side edge portion;
assembling a plurality of liner body panels formed for substantially liquid-tight connection of said body panels between an upstream edge portion of a body panel and a matching downstream edge portion of another body panel and between a left side edge portion of a body panel and a right side edge portion of another panel;
connecting such body panels together in substantially liquid-tight connection by connecting the respective matching upstream and downstream edge portions and connecting the respective left side edge portions and right side edge portions of the body panels to form a tough, continuous, load-bearing substantially liquid-tight thermoplastic liner body extending across a prepared subsurface of the industrial site;
assembling a plurality of liner perimeter panels formed for substantially liquid-tight connection of said perimeter panels to a body panel, said perimeter panels each having an edge portion selectively formed to conform to at least one of a matching upstream edge portion, downstream edge portion, right side edge portion or left side edge portion of a body panel;
connecting the matching edge portions of the perimeter panels in substantially liquid-tight relation to matching edges of the assembled body panels and connecting the raised perimeter rib portions of the perimeter panels in substantially liquid-tight relation to matching selected raised perimeter edge rib portions of other perimeter panels to form a continuous raised perimeter edge rib extending substantially around the assembly of body panels and connected thereto to form a tough, continuous, substantially liquid-tight container lining system capable of containing liquid materials leaked or discharged to or otherwise received within the confines of the containment lining system.

13. The method of claim 12, wherein the components are connected in substantially liquid-tight relation by at least one of:
adhesive bonding of overlapping matching portions of the assembled component panels;
mechanical connection of overlapping matching portions of the assembled component panels with compressed gasket and/or sealant material interbedded between overlapping connected portions;
thermoplastic fusion welding of overlapping matching portions of the assembled component panels; and
thermoplastic fusion welding of compatible thermoplastic connecting strips to each of adjacent matching portions of the assembled component panels.

14. The method of claim 12 further comprising preparing a subsurface for the containment liner comprising one or more layers of one or more bulk granular materials.

15. The method of claim 12 further comprising covering the containment liner with at least one layer of one or more granular materials.

16. The method of claim 12 further comprising covering the containment liner with a plurality of load bearing mats for supporting vehicle operation and stationary industrial equipment above the lining system.

17. The method of claim 12 wherein the containment liner components further comprise at least one cutting line located proximate to an area of overlap of connected pad liner components to facilitate removal of a portion of an edge.

18. The method of claim 12 wherein at least some of the containment liner body panels each further comprise a thermoplastic sheet formed to define a plurality of corrugations comprising alternating ribs and valleys extending perpendicularly between the upstream and downstream ends of the body panels, and further define offset corrugation ribs at one of the right or left side edge portions and a slot adapted to receive a gasket adjacent to the opposite side edge portion.
